(19) United States
(12) Patent Application Publication
(10) Pub. No.: US 2026/0091392 A1
(43) Pub. Date: Apr. 2, 2026

(54) SYSTEMS AND METHODS FOR DELIVERING REAGENTS TO A FLOW CELL

(71) Applicant: 10x Genomics, Inc., Pleasanton, CA (US)

(72) Inventors: Sarah Chan, Pleasanton, CA (US); Martin Sauzade, Pleasanton, CA (US); Yiran Zhang, Castro Valley, CA (US); Jay Kishore Nagin, Pleasanton, CA (US)

(21) Appl. No.: 19/345,389

(22) Filed: Sep. 30, 2025

Related U.S. Application Data
(60) Provisional application No. 63/702,347, filed on Oct. 2, 2024.

(51) Int. Cl. B01L 3/00

(52) U.S. Cl. CPC B01L 3/52; B01L 2200/026; B01L 2200/0684; B01L 2200/16; B01L 2300/0663; B01L 2300/0681; B01L 2300/0829; B01L 2400/0487; B01L 2400/06

(57) ABSTRACT

A system for delivering a plurality of reagents into a closed flow cell includes one or more reservoirs comprising reagents, a pump configured to cause a flow of the plurality of reagents, an aspiration device coupled to a first fluid channel, a closed flow cell having an inlet and an outlet, where the inlet is coupled to an end of the first fluid channel, and a de-bubbler coupled to the first fluid channel upstream of the closed flow cell. The de-bubbler is configured to divert one or more bubbles from the first fluid channel.

### CROSS-REFERENCE TO RELATED APPLICATIONS

This application claims the benefit of priority to U.S. Provisional App. No. 63/702,347, filed on Oct. 2, 2024. The entire contents of which are hereby incorporated by reference.

### FIELD

The present disclosure relates to systems and methods for delivering reagents into a closed flow cell.

### BACKGROUND

Many biomedical applications rely on high-throughput assays of biological samples combined with one or more reagents using flow devices (e.g., open well flow cells and closed flow cells). For example, in both research and clinical applications, high-throughput assays using target-specific reagents for analyzing molecules present in a biological sample can provide information for various applications. Reducing the amount of reagent(s) employed can significantly reduce cost, and cycle time (i.e., less volume of liquid is required to be delivered to, and removed, the tissue sample). Some exemplary fluidic systems are disclosed in U.S. Pat. Nos. 8,629,264 and 10,710,076, the entire contents of which are hereby incorporated by reference.

Interfacing of dozens of unique reagents with a flow cell is a challenging problem that is often solved by a succession of stream selectors and valves. However, streams selectors and valves are costly and are failure-prone devices that result in large dead volumes. Thus, nullifying gains offered by flow cell approaches because they demand higher volumes of reagent.

Accordingly, there exists a need for a method and system, which provides flow cells with a number of unique reagents, while ensuring low reagent usage (i.e., low dead volume), and simple and robust hardware.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a method including providing a plurality of reservoirs, each reservoir of the plurality of reservoirs containing a reagent, using an aspiration device to aspirate a first reagent from a first reservoir of the plurality of reservoirs, flowing the first reagent from the aspiration device through a first fluid channel, delivering at least a portion of the first reagent from an end of the first fluid channel into an inlet of a closed flow cell, using the aspiration device to aspirate at least one bubble into the first fluid channel, the bubble upstream of the first liquid reagent, using the aspiration device to aspirate a second reagent from a second reservoir of the plurality of reservoirs, flowing the second reagent from the aspiration device through the first fluid channel, the second liquid reagent upstream of the at least one bubble, wherein the at least one bubble separates the first liquid reagent and the second liquid reagent in the first fluid channel, diverting the at least one bubble from the first fluid channel, delivering the second reagent from the end of the first fluid channel into the inlet of the closed flow cell.

To achieve these and other advantages and in accordance with the purpose of the disclosed subject matter, as embodied and broadly described, the disclosed subject matter includes a system comprising a plurality of reservoirs comprising a plurality of reagents, each reservoir of the plurality of reservoirs containing a reagent of the plurality of reagents, a pump configured to cause a flow of the plurality of liquid reagents, an aspiration device coupled to a first end of a first fluid channel, the aspiration head configured to move about an X-axis, Y-axis and Z-axis, and to aspirate the plurality of reagents from the reagent reservoir into the first fluid channel, wherein the aspiration device is displaced outside the reagent reservoir between aspirating each reagent to draw at least one bubble into the first fluid channel such that the at least one bubble is disposed between adjacent liquid reagents within the first fluid channel, a closed flow cell having an inlet and an outlet, wherein the inlet is coupled to a second end of the first fluid channel, and a de-bubbler coupled to the first fluid channel and disposed upstream of the closed flow cell, the de-bubbler configured to divert the at least one bubble from the first fluid channel.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the method and system of the disclosed subject matter. Together with the description, the drawings serve to explain the principles of the disclosed subject matter.

### BRIEF DESCRIPTION OF THE DRAWINGS

A detailed description of various aspects, features, and embodiments of the subject matter described herein is provided with reference to the accompanying drawings, which are briefly described below. The drawings are illustrative and are not necessarily drawn to scale, with some components and features being exaggerated for clarity. The drawings illustrate various aspects and features of the present disclosure and may illustrate one or more embodiment(s) or example(s) of the present disclosure in whole or in part.

FIG. 1 is a schematic representation of a system employing a de-bubbler mechanism in accordance with the present disclosure.

FIGS. 2A-2D show a sequence of illustrations of a de-bubbler in a system shown in FIG. 1 in accordance with the present disclosure.

FIG. 3 is a schematic representation of a system employing a bubble sensor (or “bubble detector”) and valve in accordance with the present disclosure.

FIGS. 4A-4E show a sequence of illustrations of a bubble sensor in a system shown in FIG. 3 in accordance with the present disclosure.

FIGS. 5A-5E show a sequence of illustrations of bubble sensors in a system shown in FIG. 3 in accordance with the present disclosure.

FIG. 6 is a schematic representation of a system in accordance with the present disclosure.

FIGS. 7A-7D show a sequence of illustrations of a system shown in FIG. 6 in accordance with the present disclosure.

FIG. 8 is a schematic representation of a system in accordance with the present disclosure.

FIG. 9 is a schematic representation of an exemplary workflow in accordance with the present disclosure.

### DETAILED DESCRIPTION

### Definitions

To facilitate the understanding of this disclosure, a number of terms are defined below. Terms defined herein have meanings as commonly understood by a person of ordinary skill in the areas relevant to the disclosure. Terms such as “a”, “an,” and “the” are not intended to refer to only a singular entity, but include the general class of which a specific example may be used for illustration. The terminology herein is used to describe specific embodiments of the disclosure, but their usage does not limit the disclosure, except as outlined in the claims.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

The term “about,” as used herein, refers to ±10% of a recited value.

As used herein, any values provided in a range of values include both the upper and lower bounds, and any values contained within the upper and lower bounds.

The term “biological particle,” as used herein, generally refers to a discrete biological system derived from a biological sample. The biological particle may be a virus. The biological particle may be a cell or derivative of a cell. The biological particle may be an organelle from a cell. Examples of an organelle from a cell include, without limitation, a nucleus, endoplasmic reticulum, a mitochondrion, a ribosome, a Golgi apparatus, an endoplasmic reticulum, a chloroplast, an endocytic vesicle, an exocytic vesicle, a vacuole, and a lysosome. The biological particle may be a rare cell from a population of cells. The biological particle may be any type of cell, including without limitation prokaryotic cells, eukaryotic cells, bacterial, fungal, plant, mammalian, or other animal cell type, mycoplasmas, normal tissue cells, tumor cells, or any other cell type, whether derived from single cell or multicellular organisms. The biological particle may be a constituent of a cell. The biological particle may be or may include DNA, RNA, organelles, proteins, or any combination thereof. The biological particle may be or may include a matrix (e.g., a gel or polymer matrix) including a cell or one or more constituents from a cell (e.g., cell bead), such as DNA, RNA, organelles, proteins, or any combination thereof, from the cell. The biological particle may be obtained from a tissue of a subject. The biological particle may be a hardened cell. Such hardened cell may or may not include a cell wall or cell membrane. The biological particle may include one or more constituents of a cell but may not include other constituents of the cell. An example of such constituents is a nucleus or an organelle. A cell may be a live cell. The live cell may be capable of being cultured, for example, being cultured when enclosed in a gel or polymer matrix or cultured when including a gel or polymer matrix.

The term “fluidically connected”, as used herein, refers to a direct connection between at least two device elements, e.g., a channel, reservoir, etc., that allows for fluid to move between such device elements without passing through an intervening element.

The term “genome,” as used herein, generally refers to genomic information from a subject, which may be, for example, at least a portion or an entirety of a subject's hereditary information. A genome can be encoded either in DNA or in RNA. A genome can include coding regions that code for proteins as well as non-coding regions. A genome can include the sequence of all chromosomes together in an organism.

For example, the human genome has a total of 46 chromosomes. The sequence of all of these together may constitute a human genome.

The term “in fluid communication with”, as used herein, refers to a connection between at least two device elements, e.g., a channel, reservoir, etc., that allows for fluid to move between such device elements with or without passing through one or more intervening device elements.

The term “macromolecular constituent,” as used herein, generally refers to a macromolecule contained within or from a biological particle. The macromolecular constituent may include a nucleic acid. In some cases, the biological particle may be a macromolecule. The macromolecular constituent may include DNA or a DNA molecule. The macromolecular constituent may include RNA or an RNA molecule. The RNA may be coding or non-coding. The RNA may be messenger RNA (mRNA), ribosomal RNA (rRNA) or transfer RNA (tRNA), for example. The RNA may be a transcript. The RNA molecule may be (i) a clustered regularly interspaced short palindromic (CRISPR) RNA molecule (crRNA) or (ii) a single guide RNA (sgRNA) molecule. The RNA may be small RNA that are less than 200 nucleic acid bases in length, or large RNA that are greater than 200 nucleic acid bases in length. Small RNAs may include 5.8S ribosomal RNA (rRNA), 5S rRNA, transfer RNA (tRNA), microRNA (miRNA), small interfering RNA (siRNA), small nucleolar RNA (snoRNAs), Piwi-interacting RNA (piRNA), tRNA-derived small RNA (tsRNA) and small rDNA-derived RNA (srRNA). The RNA may be double-stranded RNA or single-stranded RNA. The RNA may be circular RNA. The macromolecular constituent may include a protein. The macromolecular constituent may include a peptide. The macromolecular constituent may include a polypeptide or a protein. The polypeptide or protein may be an extracellular or an intracellular polypeptide or protein. The macromolecular constituent may also include a metabolite. These and other suitable macromolecular constituents (also referred to as analytes) will be appreciated by those skilled in the art (see U.S. Pat. Nos. 10,011,872 and 10,323,278, and PCT Publication No. WO 2019/157529, each of which is incorporated herein by reference in its entirety).

The term “particulate component of a cell” refers to a discrete biological system derived from a cell or fragment thereof and having at least one dimension of 0.01 μm (e.g., at least 0.01 μm, at least 0.1 μm, at least 1 μm, at least 10 μm, or at least 100 μm). A particulate component of a cell may be, for example, an organelle, such as a nucleus, an exosome, a liposome, an endoplasmic reticulum (e.g., rough or smooth), a ribosome, a Golgi apparatus, a chloroplast, an endocytic vesicle, an exocytic vesicle, a vacuole, a lysosome, or a mitochondrion.

The terms “sample,” “tissue sample,” and “biological tissue sample” as used herein, refers to material from a subject, such as a biopsy, core biopsy, tissue section, needle aspirate, or fine needle aspirate or skin sample. The biological tissue sample may be derived from another sample. The biological sample may be a nucleic acid sample or protein sample. The sample may be a liquid sample, such as a blood sample, urine sample, or saliva sample. The sample may be a skin sample. The sample may be a cheek swap. The sample may be a plasma or serum sample. The sample may include a biological particle, e.g., a cell or virus, or a population thereof, or it may alternatively be free of biological particles. A cell-free sample may include polynucleotides. Polynucleotides may be isolated from a bodily sample that may be selected from the group consisting of blood, plasma, serum, urine, saliva, mucosal excretions, sputum, stool, and tears.

The term “sequencing,” as used herein, generally refers to methods and technologies for determining the sequence of nucleotide bases in one or more polynucleotides. The polynucleotides can be, for example, nucleic acid molecules such as deoxyribonucleic acid (DNA) or ribonucleic acid (RNA), including variants or derivatives thereof (e.g., single stranded DNA). Sequencing can be performed by various systems currently available, such as, without limitation, a sequencing system by ILLUMINA®, Pacific Biosciences (PACBIO®), Oxford NANOPORE®, or Life Technologies (ION TORRENT®). Alternatively, or in addition, sequencing may be performed using nucleic acid amplification, polymerase chain reaction (PCR) (e.g., digital PCR, quantitative PCR, or real time PCR), or isothermal amplification. Such systems may provide a plurality of raw genetic data corresponding to the genetic information of a subject (e.g., human), as generated by the systems from a sample provided by the subject. In some examples, such systems provide sequencing reads (also “reads” herein). A read may include a string of nucleic acid bases corresponding to a sequence of a nucleic acid molecule that has been sequenced. In some situations, systems and methods provided herein may be used with proteomic information.

The term “subject,” as used herein, generally refers to an animal, such as a mammal (e.g., human) or avian (e.g., bird), or other organism, such as a plant. The subject can be a vertebrate, a mammal, a mouse, a primate, a simian or a human. Animals may include, but are not limited to, farm animals, sport animals, and pets. A subject can be a healthy or asymptomatic individual, an individual that has or is suspected of having a disease (e.g., cancer) or a pre-disposition to the disease, or an individual that is in need of therapy or suspected of needing therapy. A subject can be a patient.

The term “inlet” and “port” as used herein, generally refers to an aperture, orifice or channel extending through at least a portion of a device layer.

Reference will now be made in detail to exemplary embodiments of the disclosed subject matter, an example of which is illustrated in the accompanying drawings. The method and corresponding steps of the disclosed subject matter will be described in conjunction with the detailed description of the system.

The methods, assemblies, and systems presented herein relate to an adapter configured to reduce a volume of reagent required to fully contact (e.g., submerge) a biological sample (e.g. cell or tissue sample) in an open well flow cell, thereby forming a reversible flow cell upon positioning of the adapter in the well. Reducing the volume of the open well reduces the amount of reagent(s) needed for sample preparation (e.g., tissue sample preparation for analysis of biological molecules, such as RNAs and/or proteins), which provides significant cost savings when using expensive sample preparation reagents (e.g., one or more antibodies) and can also reduce cycle time, as less time is need to dispense and remove the reagent(s) employed. For purpose of illustration and without limitation, in an exemplary embodiment, the height of liquid required in the flow cell can be reduced from approximately 1.0 mm (1000 μm) to approximately 0.2 mm (200 μm). This approximately 0.8 mm spatial reduction can reduce the amount of reagent volume used within the flow cell from 500 μl to approximately 100 μl.

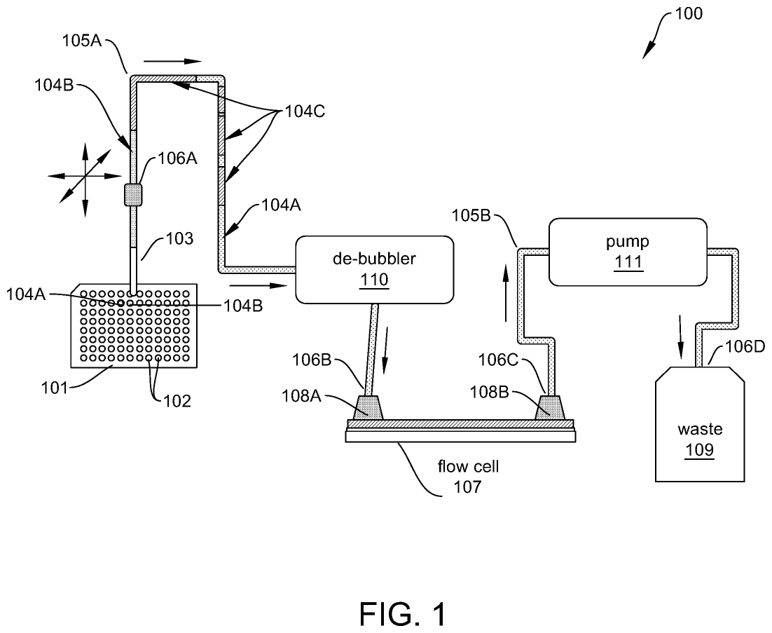

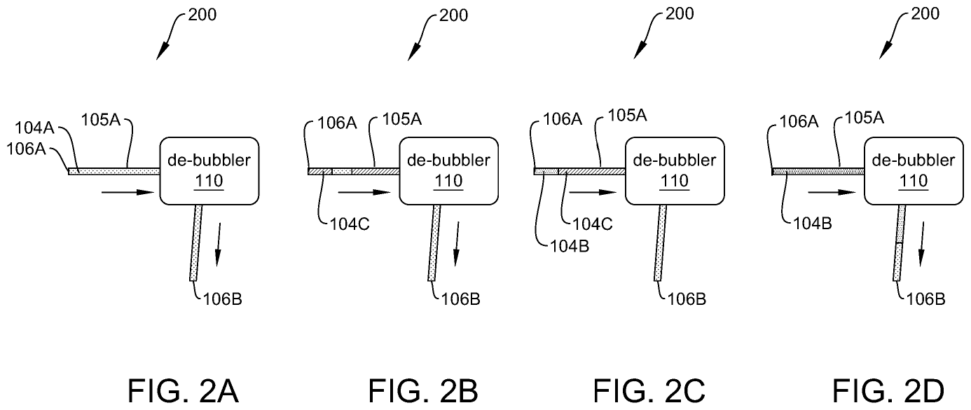

Referring now to FIG. 1, a system 100 comprises a plurality of reservoirs 102, an aspiration device 103, a first fluid channel 105A, and a closed flow cell 107. The first fluid channel 105A comprises a de-bubbler 110. The system 100 further comprises a second fluid channel 105B, with a first end 106C fluidly coupled with the flow cell 107, and a waste container 109 fluidly coupled at a second end 106D of the second fluid channel 105B. The second fluid channel 105B comprises a pump 111. The pump 111 is configured to cause a flow of reagents. In some embodiments, the pump 111 is a syringe pump. FIG. 1 depicts a volume of first reagent 104A, a volume of second reagent 104B, and bubbles 104C distributed in the first fluid channel 105A, where the bubbles separate the first reagent 104A and the second reagent 104B. In addition, a volume of the first reagent 104A is depicted flowing (indicated with the arrows in FIG. 1 and FIG. 2) through the de-bubbler 110, through the first fluid channel 105A, and into the closed flow cell 107. Still referring to FIG. 1, a volume of the first reagent 104A is depicted flowing out of the closed flow cell 107, into the second fluid channel 105B, through the pump 111, and into the waste container 109 disposed at one end of the second fluid channel 105B.

### Reservoirs

The plurality of reservoirs 102 are contained in a reagent plate 101. In some embodiment, the plurality of reservoirs 102 comprises a deep well plate. The plurality of reservoirs 102 comprise a plurality of reagents, e.g., each of the plurality of reservoirs 102 contains a reagent of the plurality of reagents. In some embodiments, each of the plurality of reagents can be different from one another. In some embodiments, at least two or more of the plurality of reagents can be the same reagent. In some embodiments, one or more reagents of the plurality of reagents is a mixture of two or more reagents (e.g. up to 1% of the reservoir volume of distinct reagents can be mixed). By way of example, a reagent of the plurality of reagents includes two or more labelled oligonucleotides, two or more labelled nucleotides, or two or more stains (e.g., antibody stains for cellular interior, antibody stains for cellular boundary, nuclear stains such as DAPI, interior RNA stain, etc.)

### Fluid Channels

In some embodiments, the length of the second channel 105B is shorter than the length of the first fluid channel 105A. In some embodiments, the inner diameter of the second channel 105B is larger than the diameter of the first fluid channel 105A. In some embodiments, the first fluid channel 105A and second fluid channel 105B comprise tubing. In some embodiments the first and second fluid channels 105A and 105B can be of equivalent length and diameter.

### Aspiration Device

The aspiration device 103 is fluidically coupled to a first end 106A of the first fluid channel 105A. The aspiration device 103 aspirates reagents from the plurality of reservoirs 102 comprising a plurality of reagents into the first fluid channel 105A. In some embodiments, the aspiration device 103 comprises a single air displacement pipette. Additionally or alternatively, the aspiration device 103 can include a plurality of air displacement pipettes. In some embodiments, the aspiration device 103 is positioned on a gantry configured to move about an X-axis, Y-axis, and Z-axis. In some embodiments, the aspiration device 103 can be manually positioned by an operator with respect to a reagent in a reservoir (e.g. a longitudinal axis of the pipette vertically aligned with the well of a reservoir). In some embodiments, the aspiration device 103 can be automatically positioned with respect to a reagent in a reservoir (e.g. coordinates of each reservoir well programmed into a controller operating the pipette movement). In some embodiments, the gantry is motorized and the desired position is controlled by a computer or an operator through a control interface.

A negative pressure can be supplied to the aspiration device 103 to draw all of the reagent within a given well of a reservoir 102. Alternatively, the aspiration device 103 can withdraw only a portion of the liquid reagent within a given well of a reservoir 102, leaving a reminder therein. The aspiration device can monitor the amount of reagent withdrawn from the reservoir 102 (e.g. flow meter within the aspiration head, or volume remaining in reservoir 102) and terminate the operation once a desired threshold is reached.

In operation, the aspiration device 103 is displaced outside of a reservoir 102 (or at least above the fluid level within a given reservoir 102) between aspirating different reagents to draw in at least one bubble into the first fluid channel 105A. Consequently, a bubble is disposed between adjacent reagents within the first fluid channel 105A. The bubble serves as a separator, and in some embodiments, cleaning agent, between distinct reagents. That is, the bubble serves as a barrier to inhibit or prohibit mixing or contamination of distinct reagents from separate reservoirs 102. Such that a first reagent can flow through the fluid channels of the system without contamination, and thereafter a bubble is drawn through the fluid channel to space subsequent reagents, and thereafter a second reagent can flow through the fluid channels without contamination or mixing with a residual of the first/prior reagent.

In some embodiments, the bubble is an air bubble, though alternative fluids can be used (e.g. nitrogen, carbon dioxide, etc.). In some embodiments, there is one bubble between distinct reagents. In some embodiments, there is one or more bubbles between distinct reagents. The bubbles can be of equivalent, or varying, volumes. In some embodiments, the aspiration device 103 aspirates at least a portion of the volume of a first reagent 104A contained within a reservoir of the plurality of reservoirs 102. In some embodiments, the aspiration device 103 aspirates different volumes from each of the plurality of reservoirs 102 containing a reagent of the plurality of reagents.

### De-Bubbler

The de-bubbler 110 can be fluidically coupled to the first fluid channel 105A and disposed upstream (relative to the direction of fluid flow) of the closed flow cell 107. The de-bubbler 110 can remove or divert the at least one bubble that is aspirated by the aspiration device 103 from the fluid channel at a location upstream from the flow cell 107. Thus, the de-bubbler 110 can be used to prevent bubbles from entering the flow cell 107. In some embodiments, the de-bubbler 110 comprises a gas-permeable membrane. In some embodiments, the de-bubbler 110 is in-line microfluidic bubble trap (PEEK Bubble remover) manufactured by Elveflow of Paris, France. In some embodiments, the de-bubbler is a pressure controller (CPC3000) manufactured by Mensor of Texas, U.S.A.

### Closed Flow Cell

The closed flow cell 107 has an inlet 108A and an outlet 108B. In some embodiments, the outlet 108B is fluidically coupled to the first end 106C of the second fluid channel 105B and the waste container 109 is disposed at the second end 106D of the second flow channel 105B. The inlet 108A of the closed flow cell 107 is fluidically coupled to a second end 106B of the first fluid channel 105A. In some embodiments, a biological sample is positioned in the closed flow cell 107. In some embodiments, delivering the first reagent 104A into the closed flow cell 107 and contacting the biological sample causes a first reaction of a biological sample within the closed flow cell 107. In some embodiments, delivering the second reagent 104B into the closed flow cell 107 causes a second reaction on the biological sample. In some embodiments, the delivery of a plurality of reagents into the closed flow cell 107 contact the biological sample and cause a plurality of reactions within the closed flow cell 107. In some embodiments, delivery of the first reagents 104A is associated with a first probing cycle of a plurality of probing cycles of the biological sample and delivery of the second reagent 104B is associated with a second probing cycle of a plurality of probing cycles of a biological sample.

### Operation of System 100

Still referring to FIG. 1, in operation, the aspiration device 103 is moved to the well containing the first reagent 104A. Using the aspiration device 103, the first reagent 104A is aspirated from a first reservoir of the plurality of reservoirs 102. Once the desired volume of the first reagent 104A is aspirated, e.g. via a pump, the first reagent 104A is then flowed from the aspiration device 103 through the first fluid channel 105A. At least a portion of the first reagent 104A is delivered from the first end 106A to the second end 106B of the first fluid channel 105A and into the inlet 108A of the closed flow cell 107.

Then, using the aspiration device 103, at least one bubble 104C is aspirated into the first fluid channel 105A; the bubble is upstream of the first reagent 104A. In some embodiments, the aspiration of a bubble into channel 105A can occur before the reagent 104A reaches the flow cell 107. In other words, a plurality of distinct reagents can simultaneously be disposed within the channel 105A, with each distinct reagent separated by a bubble. The at least one bubble 104C is aspirated by displacing the aspiration device 103 outside of the reagent reservoir.

Following aspiration of the least one bubble 104C, the aspiration device 103 is moved to the well containing the second reagent 104B. Using the aspiration device 103, the second reagent 104B is aspirated from a second reservoir of the plurality of reservoirs 102 and the second reagent 104B is upstream of the at least one bubble 104C. The at least one bubble 104C is disposed between the first reagent 104A and the second reagent 104B within the first fluid channel 105A. As the bubble travels through the first fluid channel 105A, it effectively pushes and cleans the first fluid channel 105A (i.e., removes residual liquid of the first reagent 104A in the first fluid channel 105A). Using bubbles prevents mixing of the first reagent 104A and second reagent 104B and clears the dead volumes upstream of the close flow cell to allow for efficient buffer exchange.

Additionally, the “real time” location of the bubble can be tracked as it flows throughout the first fluid channel 105A. For example, the fluid channel 105A can be made of transparent materials to serve as a “window” permitting an observer to visually detect the boundaries of the bubble (e.g. the meniscus of the leading and trailing reagents). Furthermore, the diameter and length of the first fluid channel 105A can be predetermined such that, with a known volume of reagent flowing through the first fluid channel 105A, the location of the bubble can be calculated at any given time in the operation.

When the at least one bubble 104C reaches the de-bubbler 110, the bubble is removed or diverted from the first fluid channel 105A; the at least one bubble 104C is diverted from the first fluid channel 105A prior to delivering the second reagent 104B. This allows a clean transition from injection of the first reagent 104A to injection of the second reagent 104B in the inlet 108A of the closed flow cell 107 without injecting bubbles in the closed flow cell 107 (as the presence of bubbles can damage the tissue sample contained therein). The second reagent 104B is flowed from the first end 106A to the second end 106B of the first fluid channel 105A, flowed through the de-bubbler 110, and delivered into the inlet 108A of the closed flow cell 107.

In some embodiments, at least a portion of the volume of the first reagent 104A can be flowed out of the outlet 108B of the flow cell 107, through the second flow channel 105B, and into the waste container 109. In some embodiments, at least a portion of the volume of one or more reagents aspirated by the aspiration device 103 can be flowed out of the outlet 108B of the flow cell 107, flowed through the second flow channel 105B, and into the waste container 109. In some embodiments, the de-bubbler 110 comprises a bubble sensor.

While FIG. 1 depicts a first reagent 104A and a second reagent104B flowing through the system 100, the aspiration device 103 can aspirate three or more reagents with one or more bubbles disposed between adjacent reagents. The aspiration device 103 can aspirate different volumes of each reagent.

Referring now to FIGS. 2A-2D, a sequence of illustrations of the first reagent 104A, the second reagent 104B and the bubble 104C flowing through the de-bubbler 110 of the system 100 is shown. FIG. 2A depicts the injection of the first reagent 104A including from the first end 106A of the first fluid channel 105A, through the de-bubbler 110, and to the second end 106B of the first fluid channel 105A (and into the flow cell 107, omitted in these views for clarity).

FIG. 2B depicts the bubble 104C flowing through the first fluid channel 105A followed by an injection of the second reagent 104B in FIG. 2C. The bubble 104C separates the first reagent 104A and the second reagent 104B. In some embodiments, there is no mixing of the first reagent 104A and the second reagent 104B. In some embodiments, there is up to 1% of each volume of the first reagent 104A and second reagent 104B mixed. In some embodiments, there is up to 5% of each volume of the first reagent 104A and second regent 104B mixed. The bubble 104C is diverted by the de-bubbler 110, effectively removing the bubble 104C from the fluid channels (e.g. venting into ambient air). As shown in FIG. 2D, the second reagent 104B then flows from the first end 106A of the first fluid channel 105A, through the de-bubbler 110, to the second end 106B of the first fluid channel 105B (and into the flow cell 107, omitted in these views for clarity).

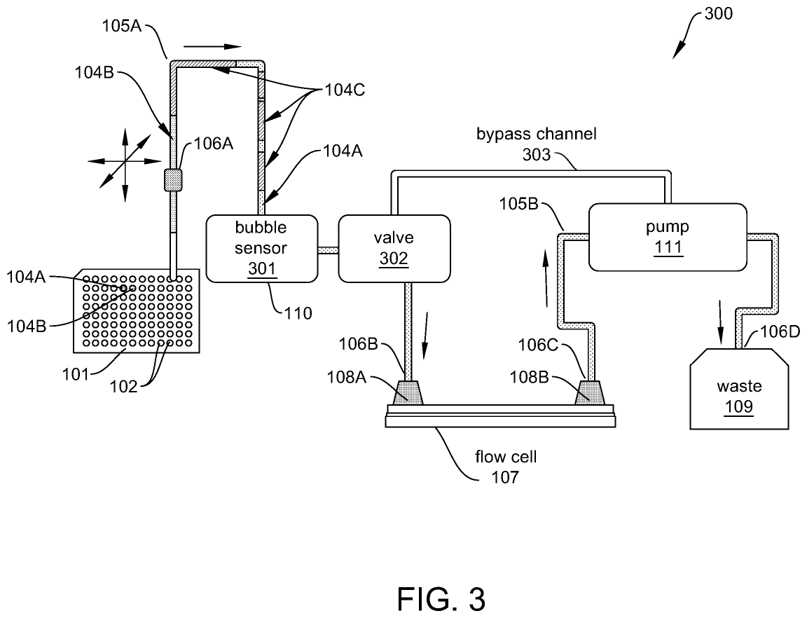

Referring now to FIG. 3, a schematic representation of a system 300 is shown comprising a plurality of reservoirs 102, an aspiration device 103, a first fluid channel 105A, and a closed flow cell 107. The first fluid channel 105A includes a bubble removing or diverting feature 110 comprising a bubble sensor 301 (or “bubble detector”), a valve 302, and a bypass channel 303. The system 300 further comprises a second fluid channel 105B. The use of a valve 302 to divert bubbles within the fluid channels is advantageous as it can accommodate a large range of pressures within the fluid channel. Also, the embodiments disclosed herein referencing a pump can operate under positive pressure (“pushing” reagents and bubbles throughout the system) or under negative pressure (“pulling” reagents and bubbles throughout the system). For purpose of illustration and not limitation, an exemplary pressure within the fluid channels is approximately 40˜160 kPa (e.g. 80 kPa) and an exemplary flow rate of reagents is approximately 25˜100 μl/s (e.g. 50 μl/s).

The second fluid channel 105B comprises a pump 111. The second fluid channel 105B has a waste container 109 disposed at a second end 106D of the second fluid channel 105B for receiving reagents after processing (e.g. contact with the tissue sample) within the flow cell 107. FIG. 3 depicts a volume of first reagent 104A, a volume of second reagent 104B, and bubbles 104C distributed in the first fluid channel 105A, where the bubbles separate the first reagent 104A and the second reagent 104B. In addition, a volume of the first reagent 104A is depicted flowing (indicated with the arrows in FIG. 2) through the bubble sensor 301, through the valve 302, and through the inlet 108A of the closed flow cell 107. Still referring to FIG. 3, a volume of the first reagent 104A is depicted flowing from the outlet 108B of the closed flow cell 107, into the second flow channel 105B, through the pump 111, and into the waste container 109. The bypass channel 303 can receive the at least one bubble from the first fluid channel 105A.

### Fluid Channels

In some embodiments, the length of at least one of the channels (i.e., the first fluid channel 105A, the second fluid channel 105B, and the bypass channel 303) is different from the other channels. In some embodiments, the lengths of all the channels are all the same. In some embodiments, the inner diameter of at least one of the channels (i.e., the first fluid channel 105A, the second fluid channel 105B, and the bypass channel 303) is different from the other channels. In some embodiments, the inner diameters of all the channels are the same. In some embodiments, the bypass channel 303 has a large inner diameter than the first fluid channel 105A. A larger inner diameter lowers the fluidic resistance in the fluid channels. In some embodiments, the bypass channel 303 comprises tubing.

### Bubble Sensor (or “De-Bubbler”)

In some embodiments, the de-bubbler 110 comprises one or more bubble sensors. In some embodiments, one or more bubble sensors are coupled in series to the first fluid channel 105A. In some embodiments, a de-bubbler as described above in connection with the embodiment of FIG. 1 can be incorporated into the embodiment shown in FIG. 3. The bubble sensor 301 can detect the presence of a bubble within the fluid channel and send an electrical signal to operate the valve 302, thereby diverting or removing the bubble from fluid channel 105 and into bypass channel 303. In some embodiments, the bubble sensor 301 can be located upstream of the valve 302 to provide sufficient lead time from detection of the bubble to operation of the valve to divert the bubble so that the bubble cannot enter the flow cell 107.

### Valve

The valve 302 can be a 3-way switch valve downstream from the de-bubbler 110 and coupled to the first fluid channel 105A and a bypass channel 303 in fluid communication with the valve 302. The valve 302 is configured to close the first fluid channel 105A upon detection of a bubble at each bubble sensor. The valve is configured to close the bypass channel 303 and open the first fluid channel 105A when no bubble is detected.

### Operation of System 300

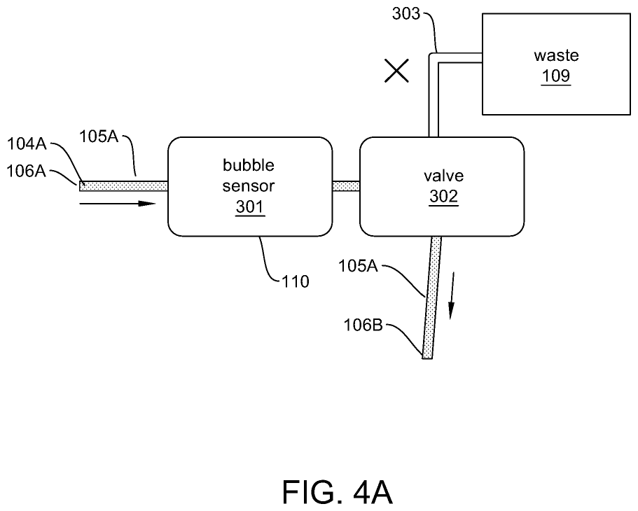

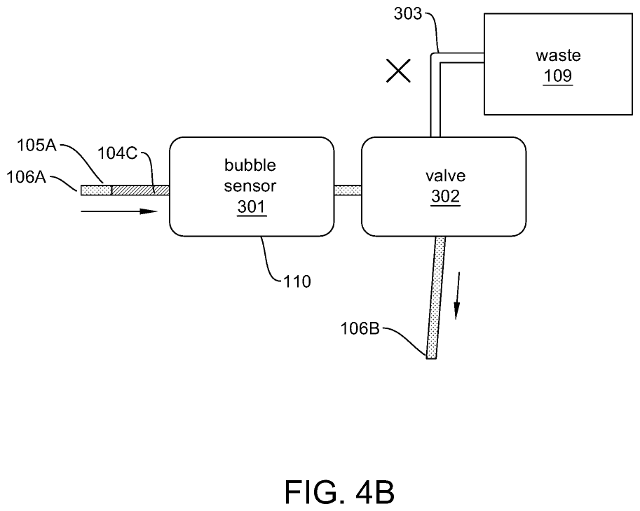

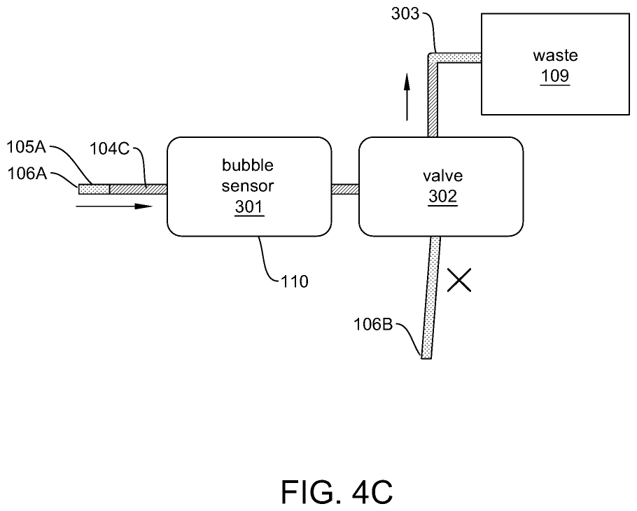

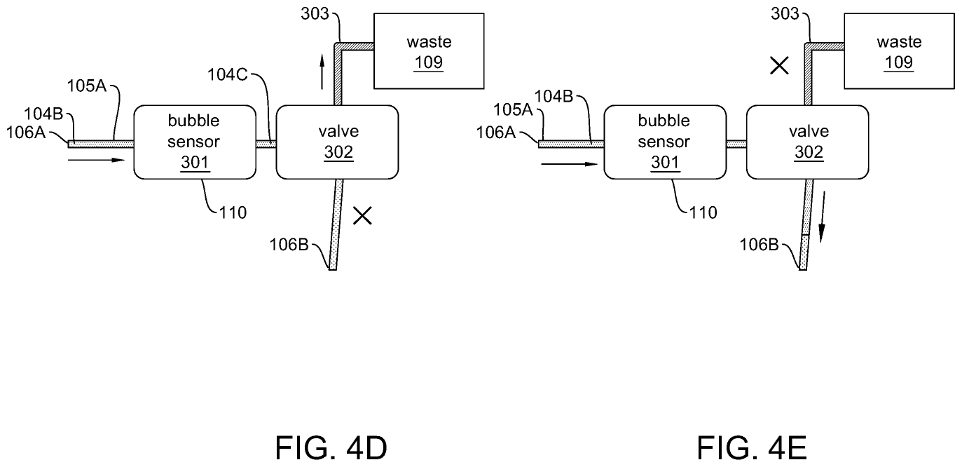

Referring to FIG. 3 and FIGS. 4A-4E, in operation, the aspiration device 103 is moved to the well containing the first reagent 104A. Using the aspiration device 103, the first reagent 104A is aspirated from a first reservoir of the plurality of reservoirs 102. Once the desired volume of the first reagent 104A is aspirated and pumped, the first reagent 104A is then flowed from the aspiration device 103 through the first fluid channel 105A. The first reagent 104A is delivered from the first end 106A to the second end 106B of the first fluid channel 105A (as shown in FIG. 4A). The first reagent 104A is then flowed from the second end 106B of the first fluid channel 105A into the inlet 108A of the closed flow cell 107.

Then, using the aspiration device 103, at least one bubble 104C is aspirated into the first fluid channel 105A; the bubble is upstream of the first reagent 104A. The at least one bubble 104C is aspirated by displacing the aspiration device 103 outside of the reagent reservoir to draw a bubble into the aspiration device 103. As the bubble travels through the first fluid channel 105A, it effectively pushes the prior reagent, and cleans the first fluid channel 105A (i.e., removes residual liquid of the first reagent 104A in the first fluid channel 105A). This prevents mixing of the first reagent 104A and second reagent 104B. When the bubble 104C reaches the de-bubbler station 110, including the bubble sensor 301, the bubble sensor 301 detects the bubble 104C as shown in FIG. 4B.

The flow rate and location (e.g. leading edge/meniscus of the bubble 104C and trailing edge/meniscus of the first reagent 104A) can be compared to determine the amount of first reagent 104A that is still traveling through the valve 302. That is, the bubble sensor 301 can send a signal to the valve 302 that is delayed or timed to close flow in fluid channel 105A once the trailing edge/meniscus of the first reagent 104A exits the valve (and proceeds into the flow cell), thereby avoiding wasting any first reagent 104A or delivering an insufficient amount of first reagent 104A to the flow cell.

As shown in FIG. 4C, once the entirety of first reagent 104A is directed though valve 302 towards the second fluid channel 106B, and the bubble 104C reaches the valve 302, the valve 302 closes the first fluid channel 105A so that the bubble 104C is diverted through the bypass channel 303. This flow path through the bypass channel 303 is maintained open until the entire bubble 104C is diverted through the valve 302 (and away from the flow cell 107), as shown in FIG. 4D.

When no bubble is detected at the bubble sensor 301 (i.e., a liquid front is detected), the valve 302 reopens the first fluid channel 105A, closes the bypass channel 303, and the second reagent 104B flows through the first fluid channel 105A from the first end 106A to the second end 106B of the first fluid channel 105A (as shown in FIG. 4E). The second reagent 104B is then flowed from the second end 106B of the first fluid channel 105A and into the inlet 108A of the closed flow cell 107.

In some embodiments, when the de-bubbler 110 comprising the bubble sensor 301 detects a bubble, the valve 302 closes the first fluid channel 105A and opens the bypass channel 303 for a period of time. In some embodiments, the period of time is set to be a constant and is determined on the initial flow rate and distance between the bubble sensor 301 and the valve 302. After the period of time, the valve 302 closes the bypass channel 303 and opens the first fluid channel 105A. In some embodiments, the time interval is variable and determined by the de-bubbler 110 comprising a flow meter.

While FIG. 3 and FIGS. 4A-4E, depict a first reagent 104A and a second reagent 104B flowing through the system 300, the aspiration device 103 can aspirate three or more reagents with one or more bubbles disposed between adjacent reagents. The aspiration device 103 can aspirate different volumes of each reagent.

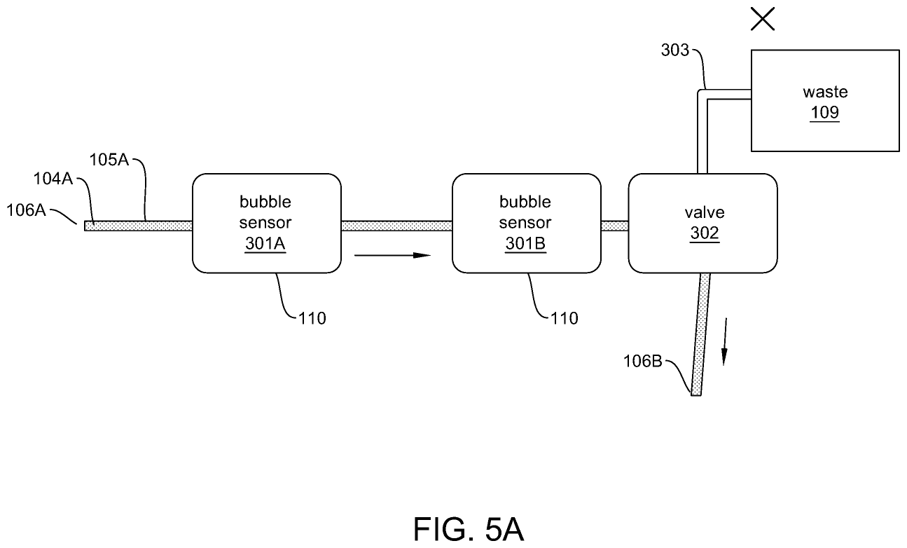

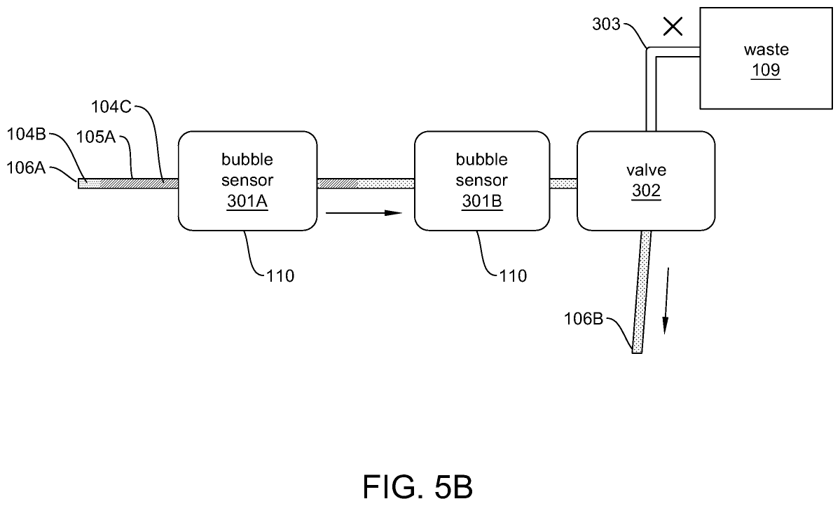

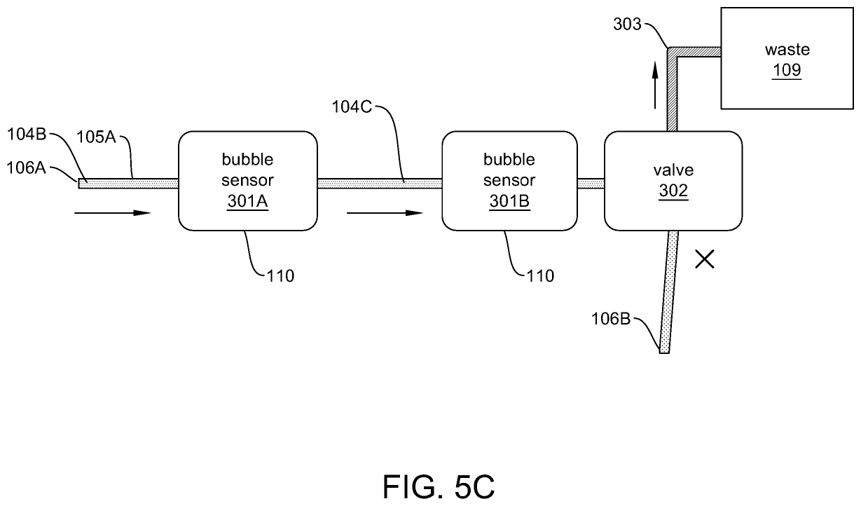

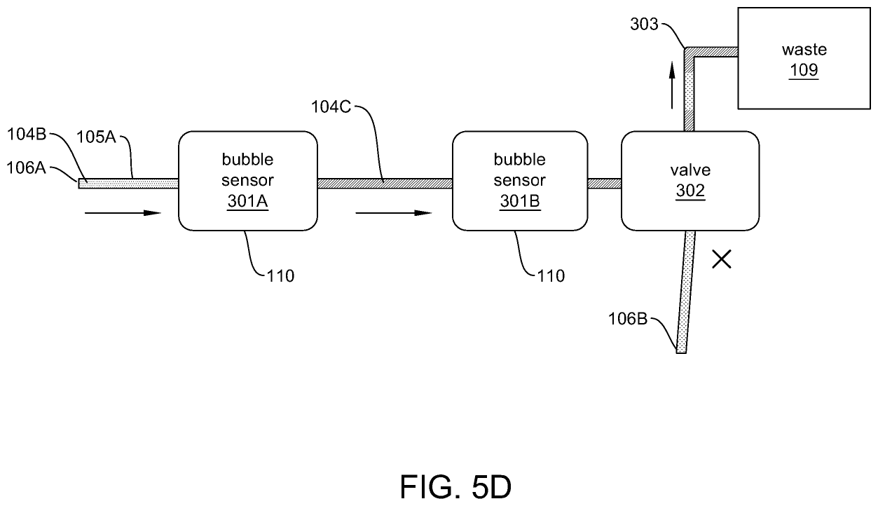

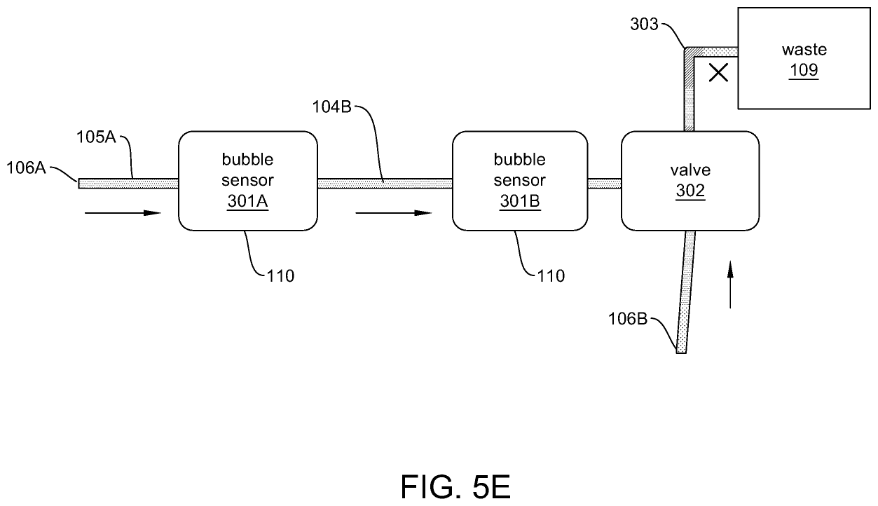

Referring now to FIGS. 5A-5E, a sequence of illustrations of the system 300 with a de-bubbler 110 comprising a plurality (e.g. two) bubble sensors 301A, 301B (in series) as a flow meter are shown. FIG. 5A depicts the injection of the first reagent 104A; the first reagent 104A, flowing from the first end 106A to the second end 106B of the first fluid channel 105A, while the valve 302 maintains the first fluid channel 105A open and fluidly coupled to the flow cell 107, and the bypass channel 303 closed. The bubble sensors 301A, 301B detect no bubble(s) as the first reagent flows through the first fluid channel 105A.

FIG. 5B depicts the bubble 104C entering the first fluid channel 105A and the front of the bubble 104C passing through the first bubble sensor 301A. As the bubble 104C passes through the first bubble sensor 301A, the first bubble sensor detects the bubble, but no bubble is detected yet at second (downstream) bubble sensor 301B. As the front of the bubble 104C continues to advance, the front of the bubble 104C passes through the second bubble sensor and is detected by the second bubble sensor 301B while the trailing edge or rear of the bubble 104C remains detected by the first bubble sensor 301A, as shown in FIG. 5C.

Consequently, as shown in FIG. 5C, the valve 302 closes the first fluid channel 105A and opens the bypass channel 303 diverting the bubble to the waste container 109. In some embodiments, some dead volume of the first reagent 104A is also diverted through the bypass channel 303. In some embodiments, only air (e.g., a bubble) is diverted through the bypass channel 303. A first period of time is measured as the time it takes for the bubble pass through the bubble sensors 301A, 301B. In other words, the first period of time is measured as the duration of time between a phase change (e.g., detection change from of a liquid to a bubble front) detected at bubble sensor 301A and the same phase change (detection of the bubble front) detected at the bubble sensor 301B. A flow rate is determined by dividing the total fluid volume between the bubble sensors 301A, 301B by the measured first period of time. The flow rate is then transmitted to the controller of the valve 302 and the valve directs the bubble 104C to the bypass channel 303 for a duration of the first period of time. The flow rate transmitted to the controller can set a delay time of valve operation.

FIG. 5D depicts the injection of the second reagent 104B; the second reagent 104B, flowing from the first end 106A to the second end 106B of the first fluid channel 105A, while the valve 302 maintains the first fluid channel 105A open and the bypass channel 303 closed. A second period of time is determined by the time it takes for both bubble sensors 301A, 301B to detect no bubbles. In other words, the second period of time is measured as the duration of time between a phase change (e.g., detection change from a bubble to a liquid front) detected at bubble sensor 301A and the same phase change (i.e., detection of the liquid front) detected at the bubble sensor 301B. A flow rate is determined by dividing the total volume of the channel between the bubble sensor 301A, 301B by the second period of time. The delay time is set by the flow rate sent to the controller of the valve 302; the second period of time is used to ensure no bubbles reach the closed flow 107. The flow rate transmitted to the controller can set a delay time of valve operation. The valve 302 then closes the bypass channel 303 and opens the first fluid channel 105A to deliver the second reagent 104B to the second end 106B of the first fluid channel 105A as shown in FIG. 5E. In some embodiments, the flow rate is determined based on the detection of a meniscus of the first reagent 104A or second reagent 104B at each of the bubble sensors 104A, 104B.

Flow sensing feedback (i.e., bubble sensing and dynamic measurements of the flow rate) varies the delay time of valve operation in response to changes in hydraulic resistance within the fluid channels of the system. The delay time of bubble detection and valve operation varies based on the diameters of the fluid channels, the length of the channels, and flow rates. Air bubbles increase the hydraulic resistance in a channel depending on a several factors including the number of bubbles in the channels, the length of bubbles in the channel, interfacial tension, and Marangoni stresses (at moderate surfactant concentrations). Changes in the hydraulic resistance in any part of the fluid channels can affect the entire system. This is most apparent when the two phases (i.e., liquid and air) share a common supply inlet and share common outlet collection channels (e.g., share same waste and pump). In addition, because air is compressible, as the bubble moves towards a lower pressure, the volume of the bubble increases and accordingly the length of the bubble in the channel increases, impacting the hydraulic resistance over the course of the movement along the pressure gradient.

### System 600

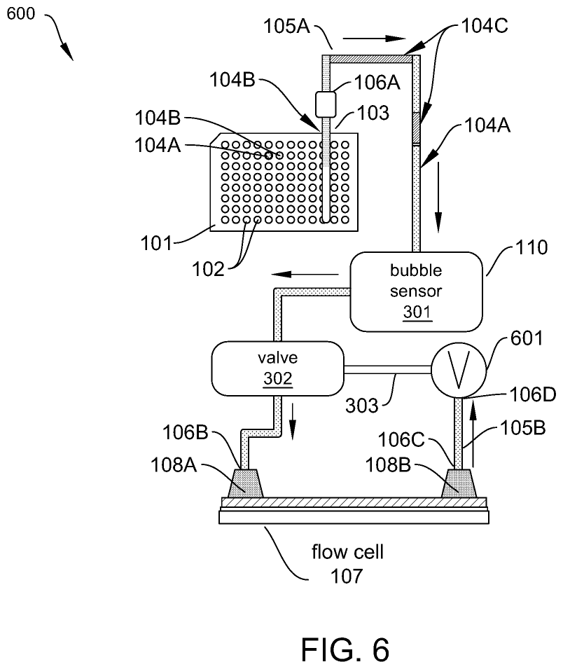

Referring now to FIG. 6, a schematic representation of a closed flow cell with bubble flushing system 600 is shown comprising a plurality of reservoirs 102, an aspiration device 103, a first fluid channel 105A, a closed flow cell 107, and bypass valve 601. The first fluid channel 105A comprises a de-bubbler 110 comprising a bubble sensor 301, a valve 302, a bypass channel 303. The plurality of reservoirs 102 comprises a reagent plate 101. The plurality of reservoirs 102 comprising a plurality of reagents including the first reagent 104A and the second reagent 104B. The aspiration device 103 is fluidically coupled to the first channel 105A at the first end 106A of the first channel 105A. The closed flow cell 107 has an inlet 108A and outlet 108B. The inlet 108A is fluidically coupled to the second end 106B of the first fluid channel 105A. The outlet 108B is fluidically coupled to the first end 106C of the second fluid channel 105B. The second end 106D of the second fluid channel 105B is fluidically coupled to the bypass channel valve 601.

### Operation of System 600

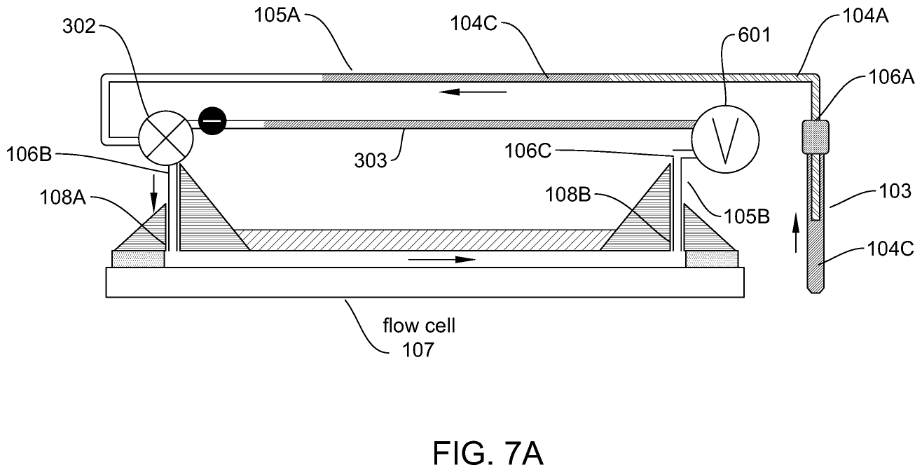

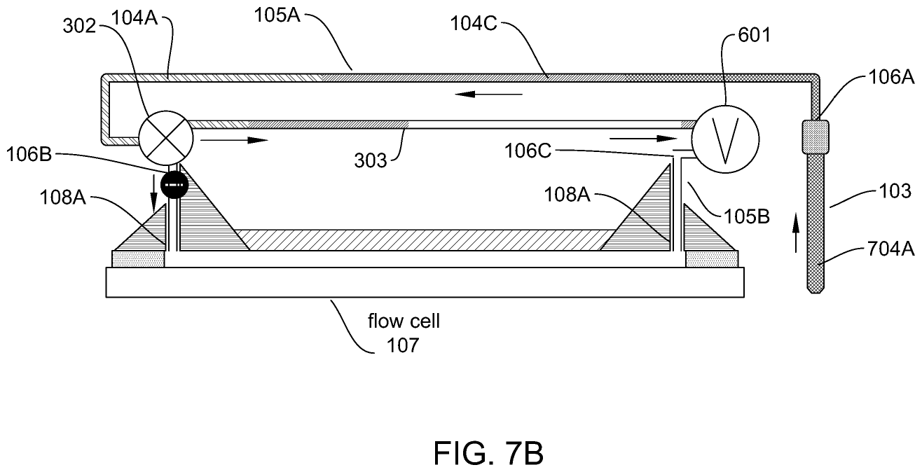

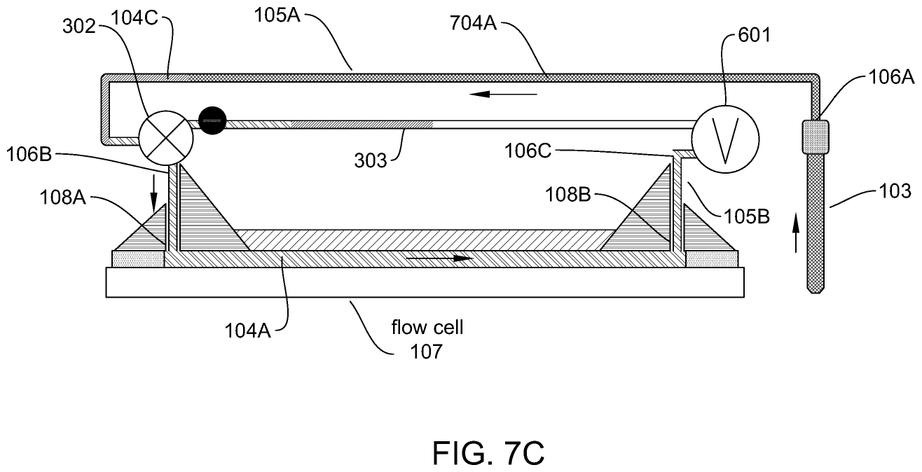

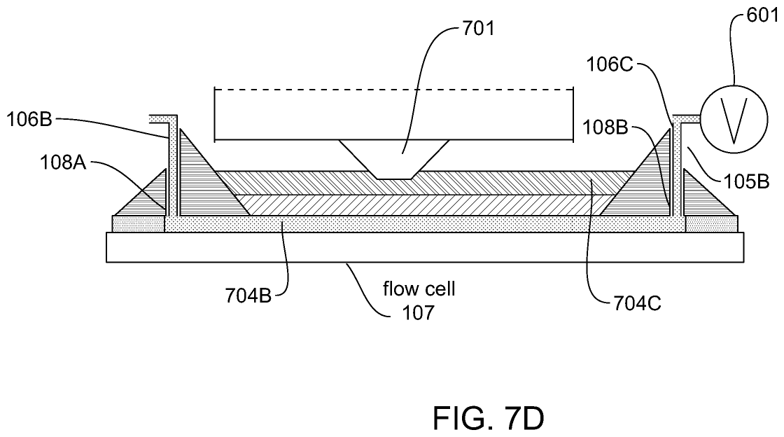

Referring to FIGS. 7A-7D, in operation, the aspiration device 103 is moved to the outside of the reagent reservoir and air is aspirated introducing a bubble of air 104C. The bubble of air 104C can be smaller in volume, e.g. a “plug”, than subsequent reagent flows, and the air bubble 104C is flowed from the aspiration device 103 through the first fluid channel 105A, as shown in FIG. 7A. The aspiration device 103 is then moved to a first reservoir of the plurality of reservoirs 102 containing the first reagent 104A. Using the aspiration device 103, the first reagent 104A is aspirated from a first reservoir of the plurality of reservoirs 102. Once the desired volume of the first reagent 104A is aspirated, another bubble 104C of air is aspirated by moving the aspiration device 103 to the outside of the reagent reservoir. The bubbles 104C are disposed on both sides of the first reagent 104A (e.g. to “sandwich” the reagent) and the three fluid segments flow through the aspiration device 103 and the first fluid channel 105A as shown in FIG. 7A.

As shown in FIG. 7B, a wash buffer 704A is then aspirated until the leading bubble 104C reaches the valve 302. The valve 302 then closes the first fluid channel 105A (to prohibit the bubble 104C from flowing toward the flow cell containing the tissue sample) and opens the bypass channel 303. The leading bubble 104C is diverted through the bypass channel 303. The valve 601 is open to atmospheric pressure enabling the removal of the leading bubble 104C.

As shown in FIG. 7C, after the leading bubble 104C is diverted, the valve 302 closes the bypass channel 303 and opens the first fluid channel 105A. The wash buffer 704A is aspirated and the first reagent 104A is flowed to the second end 106B of the first channel 105A and into the inlet 108A of the closed flow cell 107. When the trailing bubble 104C reaches the valve 302, the valve 302 closes the first fluid channel 105A and opens the bypass channel 303 to divert the trailing bubble 104C. The valve 601 is open to atmospheric pressure enabling the removal of the trailing bubble 104C.

As shown in FIG. 7D, the valve 302 closes the bypass channel 303 and opens the first fluid channel 105A and aspiration stops. The closed flow cell 107 is exchanged with imaging buffer 704B and immersion buffer 704C is dispensed into an objective immersion well for imaging.

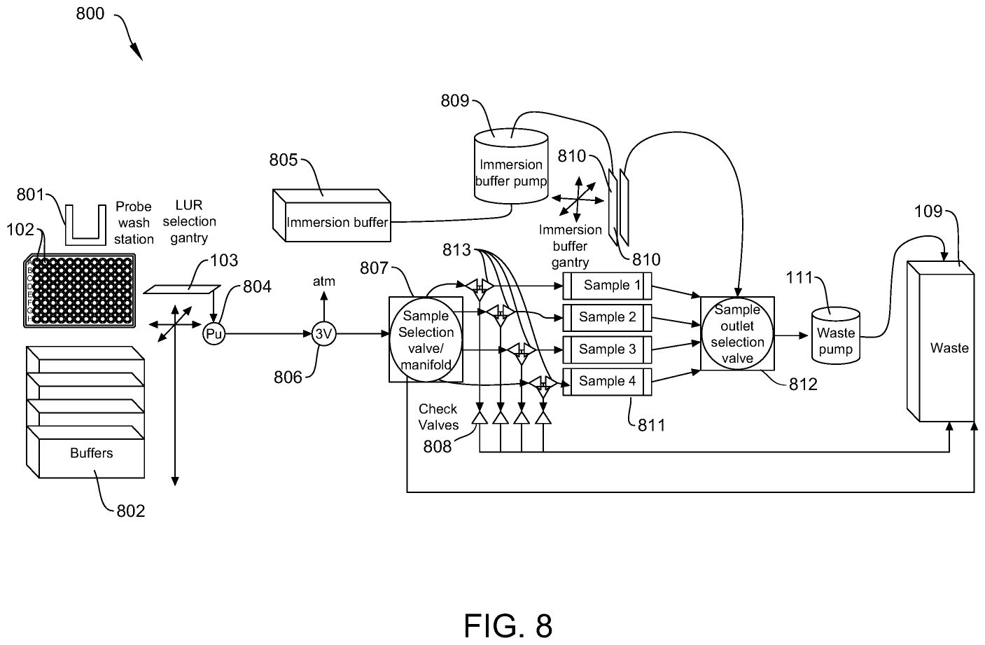

Referring to FIG. 8, a schematic representation of a system 800 is shown comprising a plurality of reservoirs 102, a probe wash station 801, a plurality of buffers 802, an aspiration device 103, a proximal pump 804, an immersion buffer 805, a 3-way valve 806, a sample selection valve 807, a plurality of T-junctions 813, a plurality of check valves 808, an immersion buffer pump 809, an immersion buffer gantry 810, a plurality of closed flow cells 811, a sample outlet selection valve 812, a pump 111, a waste container 109.

The aspiration device 103 is fluidically coupled to the pump 804. The proximal pump 804 is fluidically coupled to a first port of the 3-way valve 806. A second port of the 3-way valve 806 is fluidically coupled with the sample selection valve 807. A third port of the 3-way valve 806 is configured to be in fluid communication with atmospheric pressure. The sample selection valve 807 is fluidically coupled to an inlet of each of the plurality of T-junctions 813. A first outlet of each of the plurality of T-junctions 813 is fluidically coupled to a plurality of sample flow cells 811. A first outlet of each of the plurality of T-junctions 813 each fluidically coupled to a check valve of the plurality of check valves 808. Each of the plurality of closed flow cells 811 fluidically coupled to the sample outlet selection valve 812. The sample outlet selection valve 812 is fluidically coupled to the pump 111. The waste container 109 disposed at an end of the sample selection valve 807, the plurality of check valves 808, and the pump 111. The immersion buffer pump 809 is coupled to the immersion buffer gantry 810 which is fluidically coupled to the sample outlet selection valve 812. The immersion buffer pump 809 is configured to flow the immersion buffer 805. The probe wash station 801 is configured to rinse the probe of the aspiration device 103. The plurality of check valves 808 is configured to restrict the flow direction.

Still referring to FIG. 8, in operation, the aspiration device 103 is moved to the plurality of reservoirs 102 containing a plurality of reagents. The 3-way valve 806 is closed to atmosphere and the sample selection valve 807 is set to one of the plurality of T-junctions 813 fluidically coupled to one of the plurality of closed flow cells 811. Using the aspiration device 103, a first reagent is aspirated from a first reservoir of the plurality of reservoirs 102. Once the desired volume of the first reagent is aspirated and pumped, the first reagent is then flowed from the aspiration device 103 to the T-junction of the one of the plurality of T-junctions 813 and past the one of the plurality of check valves 808 in fluid communication. This connects the leading edge of the next reagent with the preceding reagent. The 3-way valve 806 is set to atmosphere and fluidically coupled to the sample selection valve 807. The pump 111 aspirates the reagent through the one of the plurality of closed flow cells 811 to exchange buffers. The pump can be used to transport a volume of the preceding reagent to the T-junction of the one of the plurality of T-junctions 813 to ensure that the leading edge of the next reagents connects with the trailing edge of the preceding reagent.

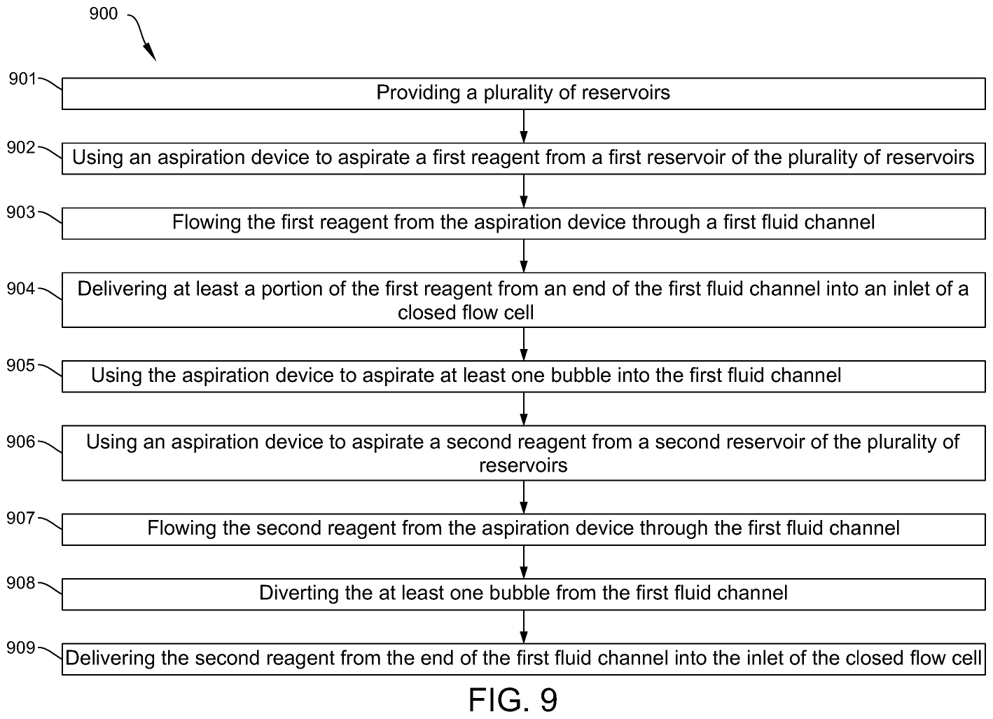

Referring to FIG. 9, illustrates a flowchart of an embodiment of a method 900 to deliver a plurality of reagents to a closed flow cell. At 901, a plurality of reservoirs is provided. At 902, an aspiration device is used to aspirate a first reagent from a first reservoir of the plurality of reservoirs. At 903, the first reagent is flowed from the aspiration device through a first fluid channel. At 904, at least a portion of the first reagent is delivered from an end of the first fluid channel into an inlet of a closed fluid cell. At 905, the aspiration device is used to aspirate at least one bubble into the first fluid channel. In some embodiments, at 905, the aspiration device is moved outside of the first reservoir. At 906, the aspiration device is used to aspirate a second reagent from a second reservoir of the plurality of reservoirs. At 907, the second reagent is flowed from the aspiration device through the first fluid channel. At 908, the at least one bubble is diverted from the first fluid channel. In some embodiments, at 908, the at least one bubble is flowed through the first fluid channel comprising a de-bubbler. In some embodiments, the first fluid channel includes a valve, a bypass channel, and/or a bubble sensor and, at 908, the valve is operated to direct the at least one bubble to the bypass channel when the bubble is located at the bubble sensor. In some embodiments, at 908, a flow rate is determined in the first fluid channel by measuring a period of time for the at least one bubble to pass through a series of bubble detectors. At 909, the second reagent is delivered from the end of the first fluid channel into the inlet of the closed flow cell. In some embodiments, the at least one bubble is diverted from the first channel prior to delivering the second reagent into the inlet of the closed flow cell.

The flow devices of the disclosure may include any suitable material, for example, polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

In some embodiments, the present devices may be assembled by alignment and stacking of the slide, tissue sample, fluidic interface layer, gasket, and adaptor. For example, the adaptor may be aligned with and placed onto the fluidic interface layer, or the adapter can be placed on the slide prior to dispensing the fluidic interface layer of reagent(s). Compression may be applied during assembly such that the fluidic interface layer, gasket, and/or substrate layer are reversibly attached. Assembly, and disassembly, can be performed manually.

### Surface Properties

A surface of the device may include a material, coating, or surface texture that determines the physical properties of the device. In particular, the flow of liquids may be controlled by the surface properties (e.g., wettability of a liquid-contacting surface). In some cases, a portion (e.g., a flow path) may have a surface having a wettability suitable for facilitating liquid flow (e.g., in a flow path).

Wetting, which is the ability of a liquid to maintain contact with a solid surface, may be measured as a function of a water contact angle. A water contact angle of a material can be measured by any suitable method known in the art, such as the static sessile drop method, pendant drop method, dynamic sessile drop method, dynamic Wilhelmy method, single-fiber Wilhelmy method, single-fiber meniscus method, and Washburn's equation capillary rise method.

For example, portions of the device carrying aqueous phases (e.g., a channel or flow path) may have a surface material or coating that is hydrophilic or more hydrophilic than the other parts of the device, e.g., include a material or coating having a water contact angle of less than or equal to about 90°, and/or other components of the device may have a surface material or coating that is hydrophobic or more hydrophobic than the flow path, e.g., include a material or coating having a water contact angle of greater than 70° (e.g., greater than 90°, greater than 95°, greater than 100° (e.g., 95°-120° or 100°-10°)). The system can be designed to have a single type of material or coating throughout. Surface textures may also be employed to control fluid flow.

The surface properties may be those of a native surface (i.e., the surface properties of the bulk material used for fabrication) or of a surface treatment. Non-limiting examples of surface treatments include, e.g., surface coatings and surface textures. In one approach, the surface properties are attributable to one or more surface coatings present in a portion. Hydrophobic coatings may include fluoropolymers (e.g., AQUAPEL® glass treatment), silanes, siloxanes, silicones, or other coatings known in the art. Other coatings include those vapor deposited from a precursor such as henicosyl-1,1,2,2-tetrahydrododecyldimethyltris(dimethylaminosilane); henicosyl-1,1,2,2-tetrahydrododecyltrichlorosilane (C12); heptadecafluoro-1,1,2,2-tetrahydrodecyltrichlorosilane (C10); nonafluoro-1,1,2,2-tetrahydrohexyltris(dimethylamino)silane; 3,3,3,4,4,5,5,6,6-nonafluorohexyltrichlorosilane; tridecafluoro-1,1,2,2-tetrahydrooctyltrichlorosilane (C8); bis(tridecafluoro-1,1,2,2-tetrahydrooctyl)dimethylsiloxymethylchlorosilane; nonafluorohexyltriethoxysilane (C6); dodecyltrichlorosilane (DTS); dimethyldichlorosilane (DDMS); or 10-undecenyltrichlorosilane (V11); pentafluorophenylpropyltrichlorosilane (C5). Hydrophilic coatings include polymers such as polysaccharides, polyethylene glycol, polyamines, and polycarboxylic acids. Hydrophilic surfaces may also be created by oxygen plasma treatment of certain materials.

A coated surface may be formed by depositing a metal oxide onto a surface of the system. Example metal oxides useful for coating surfaces include, but are not limited to, Al2O3, TiO2, SiO2, or a combination thereof. Other metal oxides useful for surface modifications are known in the art. The metal oxide can be deposited onto a surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art.

For example, an atomic layer of Al2O3 can be deposited on a surface by contacting it with trimethylaluminum (TMA) and water.

In another approach, the surface properties may be attributable to surface texture. For example, a surface may have a nanotexture, e.g., have a surface with nanometer surface features, such as cones or columns, that alters the wettability of the surface. Nanotextured surface may be hydrophilic, hydrophobic, or superhydrophobic, e.g., have a water contact angle greater than 150°. Exemplary superhydrophobic materials include Manganese Oxide Polystyrene (MnO2/PS) nano-composite, Zinc Oxide Polystyrene (ZnO/PS) nano-composite, Precipitated Calcium Carbonate, Carbon nano-tube structures, and a silica nano-coating. Superhydrophobic coatings may also include a low surface energy material (e.g., an inherently hydrophobic material) and a surface roughness (e.g., using laser ablation techniques, plasma etching techniques, or lithographic techniques in which a material is etched through apertures in a patterned mask). Examples of low surface energy materials include fluorocarbon materials, e.g., polytetrafluoroethylene (PTFE), fluorinated ethylene propylene (FEP), ethylene tetrafluoroethylene (ETFE), ethylene chloro-trifluoroethylene (ECTFE), perfluoro-alkoxyalkane (PFA), poly(chloro-trifluoro-ethylene) (CTFE), perfluoro-alkoxyalkane (PFA), and poly(vinylidene fluoride) (PVDF). Other superhydrophobic surfaces are known in the art.

In some cases, the water contact angle of a hydrophilic or more hydrophilic material or coating is less than or equal to about 90°, e.g., less than 80°, 70°, 60°, 50°, 40°, 30°, 20°, or 10°, e.g., 90°, 85°, 80°, 75°, 70°, 65°, 60°, 55°, 50°, 45°, 40°, 35°, 30°, 25°, 20°, 15°, 10°, 9°, 8°, 7°, 6°, 5°, 4°, 3°, 2°, 1°, or 0°. In some cases, the water contact angle of a hydrophobic or more hydrophobic material or coating is at least 70°, e.g., at least 80°, at least 85°, at least 90°, at least 95°, or at least 100° (e.g., about 100°, 101°, 102°, 103°, 104°, 105°, 106°, 107°, 108°, 109°, 110°, 115°, 120°, 125°, 130°, 135°, 140°, 145°, or about) 150°.

The difference in water contact angles between that of a hydrophilic or more hydrophilic material or coating and a hydrophobic or more hydrophobic material or coating may be 5° to 100°, e.g., 5° to 80°, 5° to 60°, 5° to 50°, 5° to 40°, 5° to 30°, 5° to 20°, 10° to 75°, 15° to 70°, 20° to 65°, 25° to 60°, 30 to 50°, 35° to 45°, e.g., 5°, 6°, 7°, 8°, 9°, 10°, 15°, 20°, 25°, 30°, 35°, 40°, 45°, 50°, 55°, 60, 65°, 70°, 75°, 80°, 85°, 90°, 95°, or 100°.

Surfaces may also be coated with various functional materials, e.g., metals or other electrically or magnetically conducting materials. For example, a surface may include a metal coating for electrical connectivity, detection, or resistive heating. Alternatively, such elements may be physically incorporated into a device or placed in physical contact with a device.

Surface properties may also be modified after application. Such methods include exposure to UV, ozone, plasma (e.g., oxygen, argon, etc.), UV photografting and UV induced photo-catalytic oxidation. These and other methods can alter the properties of the surface (e.g., wettability such as hydrophilicity, fluorophilicity, or hydrophobicity) or add an additional layer (e.g., biomolecules) to the surface.

The above discussion centers on the water contact angle. It will be understood that liquids employed may not be water, or even aqueous. Accordingly, the actual contact angle of a liquid on a surface may differ from the water contact angle. Furthermore, the determination of a water contact angle of a material or coating can be made on that material or coating when not incorporated into a device.

### Methods of Detection

In some embodiments, the methods described herein include detecting, e.g., tissue, cells, particulate components thereof, or other analytes. A sensor (e.g., optical, electrical, magnetic, impedance, or fluorescent sensor) in the detector may sense a particular feature (e.g., fluorescence, charge) or characteristic (e.g., diameter or volume) of sample (e.g., a cell or group of cells in a tissue sample).

Methods of detection include optical detection, e.g., by visual observation, e.g., using an optical bright-field. In some embodiments, analytes thereof are detectable by light absorbance, scatter, emission, and/or transmission. Additionally, or alternatively, optical detection can include fluorescent detection, e.g., by fluorescent microscopy. In still further embodiments, methods of the disclosure include detection of analytes having electrical or magnetic labels or properties. In some embodiments, the device includes a plurality (e.g., 2, 3, 4, 5, 6, 7, 8, 9, 10, or more) of detectors. Detectors may or may not be integrated with the device. In some embodiments, the substrate layer and/or fluid interface layer may be transparent, or include transparent portions, e.g., to allow for visualization, imaging, or detection. Substrate layers or fluidic interface layers, or portions thereof, may include transparent materials such as glass, quartz, polystyrene, polyethylene terephthalate, etc. The detection methods described herein may be automated, e.g., including robotic systems.

A variety of analytes, e.g., tissue, cell, or particulate component or macromolecular constituent thereof, characteristics can be observed and/or quantified. For example, characteristics such as analyte, e.g., cell, or particulate component or macromolecular constituent thereof, size (e.g., diameter) and shape can be readily observed visually and recorded by image or video acquisition software known in the art. In addition, the number of analytes, e.g., cell or particulate component thereof, can similarly be observed visually, by using detectable labels, or by other optical characteristics (e.g., scatter, absorbance, transmission, emission, such as fluorescence, etc.). In some embodiments, methods of the disclosure include observing the presence and/or intensity of a fluorescently or ionically tagged antigen-binding molecule bound to a biological antigen (e.g., a protein or nucleic acid, e.g., associated with an intact cell).

### Preparation of Samples

A variety of steps can be performed to prepare a biological tissue sample for analysis. In some embodiments, a sample is collected or deposited in the device described herein and prepared using a device described herein. In some embodiments, a prepared sample is placed on a substrate layer described herein. Except where indicated otherwise, the preparative steps described below can generally be combined in any manner to appropriately prepare a particular sample for analysis. In some aspects, any of the preparative or processing steps described can be performed on a sample using a device described herein, e.g., to deliver reagents via a fluid source. For example, the preparing or processing may include but is not limited to steps for fixing, embedding, staining, crosslinking, permeabilizing the sample, providing and/or removing reagents (e.g., probes, enzymes, buffers, etc.) or any combinations thereof.

A biological tissue sample can be harvested from a subject (e.g., via surgical biopsy, whole subject sectioning), grown in vitro on a growth substrate or culture dish as a population of cells, or prepared as a tissue slice or tissue section. Grown samples may be sufficiently thin for analysis without further processing steps. Alternatively, grown samples, and samples obtained via biopsy or sectioning, can be prepared as thin tissue sections using a mechanical cutting apparatus such as a vibrating blade microtome. As another alternative, in some embodiments, a thin tissue section can be prepared by applying a touch imprint of a biological sample to a suitable substrate material.

The thickness of the tissue section can be a fraction of (e.g., less than 0.9, 0.8, 0.7, 0.6, 0.5, 0.4, 0.3, 0.2, or 0.1) the maximum cross-sectional dimension of a cell. However, tissue sections having a thickness that is larger than the maximum cross-section cell dimension can also be used. For example, cryostat sections can be used, which can be, e.g., from about 10 μm to about 20 μm thick.

More generally, the thickness of a tissue section typically depends on the method used to prepare the section and the physical characteristics of the tissue, and therefore sections having a wide variety of different thicknesses can be prepared and used. For example, the thickness of the tissue section can be at least 0.1, 0.2, 0.3, 0.4, 0.5, 0.7, 1.0, 1.5, 2, 3, 4, 5, 6, 7, 8, 9, 10, 12, 13, 14, 15, 20, 30, 40, or 50 μm. Thicker sections can also be used if desired or convenient, e.g., at least 70, 80, 90, or 100 μm or more. Typically, the thickness of a tissue section is about 1-100 μm, 1-50 μm, 1-30 μm, 1-25 μm, 1-20 μm, 1-15 μm, 1-10 μm, 2-8 μm, 3-7 μm, or 4-6 μm, but as mentioned above, sections with thicknesses larger or smaller than these ranges can also be analyzed.

Multiple sections can also be obtained from a single biological sample. For example, multiple tissue sections can be obtained from a surgical biopsy sample by performing serial sectioning of the biopsy sample using a sectioning blade. Spatial information among the serial sections can be preserved in this manner, and the sections can be analyzed successively to obtain three-dimensional information about the biological sample.

In some embodiments, the biological tissue sample (e.g., a tissue section as described above) can be prepared by deep freezing at a temperature suitable to maintain or preserve the integrity (e.g., the physical characteristics) of the tissue structure. Such a temperature can be, e.g., less than −20° C., or less than −25° C., −30° C., −40° C., −50° C., −60° C., −70° C., 80° C. −90° C., −100° C., −110° C., −120° C., −130° C., −140° C., −150° C., −160° C., −170° C., −180° C., −190° C., or −200° C. The frozen tissue sample can be sectioned, e.g., thinly sliced, onto a substrate surface using any number of suitable methods. For example, a tissue sample can be prepared using a chilled microtome (e.g., a cryostat) set at a temperature suitable to maintain both the structural integrity of the tissue sample and the chemical properties of the nucleic acids in the sample. Such a temperature can be, e.g., less than −15° C., less than −20° C., or less than −25° C. A sample can be snap frozen in isopentane and liquid nitrogen. Frozen samples can be stored in a sealed container prior to embedding.

### Fixation and Postfixation

In some embodiments, the biological sample can be prepared using formalin-fixation and paraffin-embedding (FFPE), which are established methods. In some embodiments, cell suspensions and other non-tissue samples can be prepared using formalin-fixation and paraffin-embedding. Following fixation of the sample and embedding in a paraffin or resin block, the sample can be sectioned as described above. Prior to analysis, the paraffin-embedding material can be removed from the tissue section (e.g., deparaffinization) by incubating the tissue section in an appropriate solvent (e.g., xylene) followed by a rinse (e.g., 99.5% ethanol for 2 minutes, 96% ethanol for 2 minutes, and 70% ethanol for 2 minutes).

As an alternative to formalin fixation described above, a biological sample can be fixed in any of a variety of other fixatives to preserve the biological structure of the sample prior to analysis. For example, a sample can be fixed via immersion in ethanol, methanol, acetone, paraformaldehyde (PFA)-Triton, and combinations thereof.

In some embodiments, acetone fixation is used with fresh frozen samples, which can include, but are not limited to, cortex tissue, mouse olfactory bulb, human brain tumor, human post-mortem brain, and breast cancer samples. When acetone fixation is performed, pre-permeabilization steps (described below) may not be performed. Alternatively, acetone fixation can be performed in conjunction with permeabilization steps.

In some embodiments, the methods provided herein includes one or more post-fixing (also referred to as postfixation) steps. In some embodiments, one or more post-fixing step is performed after contacting a sample with a polynucleotide disclosed herein, e.g., one or more probes such as a circular or padlock probe. In some embodiments, one or more post-fixing step is performed after a hybridization complex including a probe and a target is formed in a sample. In some embodiments, one or more post-fixing step is performed prior to a ligation reaction disclosed herein, such as the ligation to circularize a padlock probe.

In some embodiments, one or more post-fixing step is performed after contacting a sample with a binding or labelling agent (e.g., an antibody or antigen binding fragment thereof) for a non-nucleic acid analyte such as a protein analyte. The labelling agent can include a nucleic acid molecule (e.g., reporter oligonucleotide) including a sequence corresponding to the labelling agent and therefore corresponds to (e.g., uniquely identifies) the analyte. In some embodiments, the labelling agent can include a reporter oligonucleotide including one or more barcode sequences.

A post-fixing step may be performed using any suitable fixation reagent disclosed herein, for example, 3% (w/v) paraformaldehyde in DEPC-PBS.

### Embedding

As an alternative to paraffin embedding described above, a biological sample can be embedded in any of a variety of other embedding materials to provide structural substrate to the sample prior to sectioning and other handling steps. In some cases, the embedding material can be removed e.g., prior to analysis of tissue sections obtained from the sample. Suitable embedding materials include, but are not limited to, waxes, resins (e.g., methacrylate resins), epoxies, and agar.

In some embodiments, the biological sample can be embedded in a matrix (e.g., a hydrogel matrix). Embedding the sample in this manner typically involves contacting the biological sample with a hydrogel such that the biological sample becomes surrounded by the hydrogel. For example, the sample can be embedded by contacting the sample with a suitable polymer material, and activating the polymer material to form a hydrogel. In some embodiments, the hydrogel is formed such that the hydrogel is internalized within the biological sample.

In some embodiments, the biological sample is immobilized in the hydrogel via cross-linking of the polymer material that forms the hydrogel. Cross-linking can be performed chemically and/or photochemically, or alternatively by any other hydrogel-formation method known in the art.

The composition and application of the hydrogel-matrix to a biological sample typically depends on the nature and preparation of the biological sample (e.g., sectioned, non-sectioned, type of fixation). As one example, where the biological sample is a tissue section, the hydrogel-matrix can include a monomer solution and an ammonium persulfate (APS) initiator/tetramethylethylenediamine (TEMED) accelerator solution. As another example, where the biological sample consists of cells (e.g., cultured cells or cells disassociated from a tissue sample), the cells can be incubated with the monomer solution and APS/TEMED solutions. For cells, hydrogel-matrix gels are formed in compartments, including but not limited to devices used to culture, maintain, or transport the cells. For example, hydrogel-matrices can be formed with monomer solution plus APS/TEMED added to the compartment to a depth ranging from about 0.1 μm to about 2 mm.

Additional methods and aspects of hydrogel embedding of biological samples are described for example in Chen et al., Science 347(6221):543-548, 2015, the entire contents of which are incorporated herein by reference.

### Staining and Immunohistochemistry (INC)

To facilitate visualization, biological samples can be stained using a wide variety of stains and staining techniques. In some embodiments, for example, a sample can be stained using any number of stains and/or immunohistochemical reagents. One or more staining steps may be performed to prepare or process a biological sample for an assay described herein or may be performed during and/or after an assay. In some instances, the provided methods and devices for the reversible assembly and use of a flowcell allow access to the sample after performing fluidic operations. In some cases, the provided flowcell can be sealed then access can be gained to the sample without disrupting the sample (e.g., to perform staining or IHC after performing other fluidic steps of an assay). In some embodiments, the sample can be contacted with one or more nucleic acid stains, membrane stains (e.g., cellular or nuclear membrane), cytological stains, or combinations thereof. In some examples, the stain may be specific to proteins, phospholipids, DNA (e.g., dsDNA, ssDNA), RNA, an organelle or compartment of the cell. The sample may be contacted with one or more labeled antibodies (e.g., a primary antibody specific for the analyte of interest and a labeled secondary antibody specific for the primary antibody). In some embodiments, cells in the sample can be segmented using one or more images taken of the stained sample.

In some embodiments, the stain is performed using a lipophilic dye. In some examples, the staining is performed with a lipophilic carbocyanine or aminostyryl dye, or analogs thereof (e.g., Dil, DiO, DiR, DiD). Other cell membrane stains may include FM and RH dyes or immunohistochemical reagents specific for cell membrane proteins. In some examples, the stain may include but is not limited to, acridine orange, acid fuchsin, Bismarck brown, carmine, coomassie blue, cresyl violet, DAPI, eosin, ethidium bromide, acid fuchsine, haematoxylin, Hoechst stains, iodine, methyl green, methylene blue, neutral red, Nile blue, Nile red, osmium tetroxide, ruthenium red, propidium iodide, rhodamine (e.g., rhodamine B), or safranine, or derivatives thereof. In some embodiments, the sample may be stained with haematoxylin and eosin (H&E).

In some embodiments, biological samples can be destained. Methods of destaining or discoloring a biological sample are known in the art, and generally depend on the nature of the stain(s) applied to the sample. For example, in some embodiments, one or more immunofluorescent stains are applied to the sample via antibody coupling. Such stains can be removed using techniques such as cleavage of disulfide linkages via treatment with a reducing agent and detergent washing, chaotropic salt treatment, treatment with antigen retrieval solution, and treatment with an acidic glycine buffer. Methods for multiplexed staining and destaining are described, for example, in Bolognesi et al., J. Histochem. Cytochem. 2017; 65(8): 431-444, Lin et al., Nat Commun. 2015; 6:8390, Pirici et al., J. Histochem. Cytochem. 2009; 57:567-75, and Glass et al., J. Histochem. Cytochem. 2009; 57:899-905, the entire contents of each of which are incorporated herein by reference.

### Isometric Expansion

In some embodiments, a biological sample embedded in a matrix (e.g., a hydrogel) can be isometrically expanded. Isometric expansion methods that can be used include hydration, a preparative step in expansion microscopy, as described in Chen et al., Science 347(6221):543-548, 2015.

Isometric expansion can be performed by anchoring one or more components of a biological sample (e.g., nucleic acids, proteins) to a gel, followed by gel formation, proteolysis, and swelling. In some embodiments, analytes in the sample, products of the analytes, and/or probes associated with analytes in the sample can be anchored to the matrix (e.g., hydrogel). Isometric expansion of the biological sample can occur prior to immobilization of the biological sample on a substrate, or after the biological sample is immobilized to a substrate. In some embodiments, the isometrically expanded biological sample can be removed from the substrate prior to contacting the substrate with probes disclosed herein.

Isometric expansion of the sample can increase the spatial resolution of the subsequent analysis of the sample. The increased resolution in spatial profiling can be determined by comparison of an isometrically expanded sample with a sample that has not been isometrically expanded.

In some embodiments, a biological sample is isometrically expanded to a size at least 2×, 2.1×, 2.2×, 2.3×, 2.4×, 2.5×, 2.6×, 2.7×, 2.8×, 2.9×, 3×, 3.1×, 3.2×, 3.3×, 3.4×, 3.5×, 3.6×, 3.7×, 3.8×, 3.9×, 4×, 4.1×, 4.2×, 4.3×, 4.4×, 4.5×, 4.6×, 4.7×, 4.8×, or 4.9× its non-expanded size. In some embodiments, the sample is isometrically expanded to at least 2× and less than 20× of its non-expanded size.

### Crosslinking and De-Crosslinking

In some embodiments, the biological sample is reversibly cross-linked. In some aspects, the analytes, polynucleotides and/or product of an analyte or a probe bound thereto can be anchored to a polymer matrix. For example, the polymer matrix can be a hydrogel. In some embodiments, portions of the sample can be modified to contain functional groups that can be used as an anchoring site to attach the polynucleotide probes and/or amplification product to a polymer matrix. In some embodiments, a modified probe including oligo dT may be used to bind to mRNA molecules of interest, followed by reversible crosslinking of the mRNA molecules.

In some embodiments, a hydrogel can include hydrogel subunits, such as, but not limited to, acrylamide, bis-acrylamide, polyacrylamide and derivatives thereof, poly(ethylene glycol) and derivatives thereof (e.g. PEG-acrylate (PEG-DA), PEG-RGD), gelatin-methacryloyl (GeIMA), methacrylated hyaluronic acid (MeHA), polyaliphatic polyurethanes, polyether polyurethanes, polyester polyurethanes, polyethylene copolymers, polyamides, polyvinyl alcohols, polypropylene glycol, polytetramethylene oxide, polyvinyl pyrrolidone, polyacrylamide, poly(hydroxyethyl acrylate), and poly(hydroxyethyl methacrylate), collagen, hyaluronic acid, chitosan, dextran, agarose, gelatin, alginate, protein polymers, methylcellulose, and the like, and combinations thereof.

In some embodiments, a hydrogel includes a hybrid material, e.g., the hydrogel material includes elements of both synthetic and natural polymers. Examples of suitable hydrogels are described, for example, in U.S. Pat. Nos. 6,391,937, 9,512,422, and 9,889,422, and in U.S. Patent Application Publication Nos. 2017/0253918, 2018/0052081 and 2010/0055733, the entire contents of each of which are incorporated herein by reference.

In some embodiments, the hydrogel can form the substrate. In some embodiments, the substrate includes a hydrogel and one or more second materials. In some embodiments, the hydrogel is placed on top of one or more second materials. For example, the hydrogel can be pre-formed and then placed on top of, underneath, or in any other configuration with one or more second materials. In some embodiments, hydrogel formation occurs after contacting one or more second materials during formation of the substrate. Hydrogel formation can also occur within a structure (e.g., wells, ridges, projections, and/or markings) located on a substrate.

In some embodiments, hydrogel formation on a substrate occurs before, contemporaneously with, or after the sample is in the device. For example, hydrogel formation can be performed on the sample on the substrate layer.

In some embodiments, hydrogel formation occurs within a biological sample. In some embodiments, a biological sample (e.g., tissue section) is embedded in a hydrogel. In some embodiments, hydrogel subunits are infused into the biological sample, and polymerization of the hydrogel is initiated by an external or internal stimulus.

In embodiments in which a hydrogel is formed within a biological sample, functionalization chemistry can be used. In some embodiments, functionalization chemistry includes hydrogel-tissue chemistry (HTC). Any hydrogel-tissue backbone (e.g., synthetic or native) suitable for HTC can be used for anchoring biological macromolecules and modulating functionalization. Non-limiting examples of methods using HTC backbone variants include CLARITY, PACT, ExM, SWITCH and ePACT. In some embodiments, hydrogel formation within a biological sample is permanent. For example, biological macromolecules can permanently adhere to the hydrogel allowing multiple rounds of interrogation. In some embodiments, hydrogel formation within a biological sample is reversible.

In some embodiments, a method disclosed herein includes de-crosslinking the reversibly cross-linked biological sample. The de-crosslinking does not need to be complete. In some embodiments, only a portion of crosslinked molecules in the reversibly cross-linked biological sample are de-crosslinked and allowed to migrate.

### Tissue Permeabilization and Treatment

In some embodiments, a biological sample can be permeabilized to facilitate transfer of analytes out of the sample, and/or to facilitate transfer of species (such as probes) into the sample. If a sample is not permeabilized sufficiently, the amount of analyte captured from the sample may be too low to enable adequate analysis. Conversely, if the tissue sample is too permeable, the relative spatial relationship of the analytes within the tissue sample can be lost. Hence, a balance between permeabilizing the tissue sample enough to obtain good signal intensity while still maintaining the spatial resolution of the analyte distribution in the sample is desirable.

In general, a biological sample can be permeabilized by exposing the sample to one or more permeabilizing agents. Suitable agents for this purpose include, but are not limited to, organic solvents (e.g., acetone, ethanol, and methanol), cross-linking agents (e.g., paraformaldehyde), detergents (e.g., saponin, Triton X100™ or Tween-20™), and enzymes (e.g., trypsin, proteases). In some embodiments, the biological sample can be incubated with a cellular permeabilizing agent to facilitate permeabilization of the sample. Additional methods for sample permeabilization are described, for example, in Jamur et al., Method Mol. Biol. 588:63-66, 2010, the entire contents of which are incorporated herein by reference. Any suitable method for sample permeabilization can generally be used in connection with the samples described herein.

In some embodiments, the biological sample can be permeabilized by adding one or more lysis reagents to the sample. Examples of suitable lysis agents include, but are not limited to, bioactive reagents such as lysis enzymes that are used for lysis of different cell types, e.g., gram positive or negative bacteria, plants, yeast, mammalian, such as lysozymes, achromopeptidase, lysostaphin, labiase, kitalase, lyticase, and a variety of other commercially available lysis enzymes.

Other lysis agents can additionally or alternatively be added to the biological sample to facilitate permeabilization. For example, surfactant-based lysis solutions can be used to lyse sample cells. Lysis solutions can include ionic surfactants such as, for example, sarcosyl and sodium dodecyl sulfate (SDS). More generally, chemical lysis agents can include, without limitation, organic solvents, chelating agents, detergents, surfactants, and chaotropic agents.

In some embodiments, the biological sample can be permeabilized by non-chemical permeabilization methods. Non-chemical permeabilization methods are known in the art. For example, non-chemical permeabilization methods that can be used include, but are not limited to, physical lysis techniques such as electroporation, mechanical permeabilization methods (e.g., bead beating using a homogenizer and grinding balls to mechanically disrupt sample tissue structures), acoustic permeabilization (e.g., sonication), and thermal lysis techniques such as heating to induce thermal permeabilization of the sample.

Additional reagents can be added to a biological sample to perform various functions prior to analysis of the sample. In some embodiments, Dnase and Rnase inactivating agents or inhibitors such as proteinase K, and/or chelating agents such as EDTA, can be added to the sample. For example, a method disclosed herein may include a step for increasing accessibility of a nucleic acid for binding, e.g., a denaturation step to opening up DNA in a cell for hybridization by a probe. For example, proteinase K treatment may be used to free up DNA with proteins bound thereto.

### Analytes

The methods and compositions disclosed herein can be used to detect and analyze a wide variety of different analytes. In some aspects, an analyte can include any biological substance, structure, moiety, or component to be analyzed. In some aspects, a target disclosed herein may similarly include any analyte of interest. In some examples, a target or analyte can be directly or indirectly detected.

Analytes can be derived from a specific type of cell and/or a specific sub-cellular region. For example, analytes can be derived from cytosol, from cell nuclei, from mitochondria, from microsomes, and more generally, from any other compartment, organelle, or portion of a cell. Permeabilizing agents that specifically target certain cell compartments and organelles can be used to selectively release analytes from cells for analysis, and/or allow access of one or more reagents (e.g., probes for analyte detection) to the analytes in the cell or cell compartment or organelle.

The analyte may include any biomolecule or chemical compound, including a macromolecule such as a protein or peptide, a lipid or a nucleic acid molecule, or a small molecule, including organic or inorganic molecules. The analyte may be a cell or a microorganism, including a virus, or a fragment or product thereof. An analyte can be any substance or entity for which a specific binding partner (e.g., an affinity binding partner) can be developed. Such a specific binding partner may be a nucleic acid probe (for a nucleic acid analyte) and may lead directly to the generation of a product. Alternatively, the specific binding partner may be coupled to a nucleic acid, which may be detected.

Analytes of particular interest may include nucleic acid molecules, such as DNA (e.g., genomic DNA, mitochondrial DNA, plastid DNA, viral DNA, etc.) and RNA (e.g., mRNA, microRNA, rRNA, snRNA, viral RNA, etc.), and synthetic and/or modified nucleic acid molecules, (e.g., including nucleic acid domains including or consisting of synthetic or modified nucleotides such as LNA, PNA, morpholino, etc.), proteinaceous molecules such as peptides, polypeptides, proteins or prions or any molecule which includes a protein or polypeptide component, etc., or fragments thereof, or a lipid or carbohydrate molecule, or any molecule which include a lipid or carbohydrate component. The analyte may be a single molecule or a complex that contains two or more molecular subunits, e.g., including but not limited to protein-DNA complexes, which may or may not be covalently bound to one another, and which may be the same or different. Thus, in addition to cells or microorganisms, such a complex analyte may also be a protein complex or protein interaction. Such a complex or interaction may thus be a homo-or hetero-multimer. Aggregates of molecules, e.g., proteins may also be target analytes, for example aggregates of the same protein or different proteins. The analyte may also be a complex between proteins or peptides and nucleic acid molecules such as DNA or RNA, e.g., interactions between proteins and nucleic acids, e.g., regulatory factors, such as transcription factors, and DNA or RNA.

### Endogenous Analytes

In some embodiments, an analyte herein is endogenous to a biological sample and can include nucleic acid analytes and non-nucleic acid analytes. Methods and compositions disclosed herein can be used to analyze nucleic acid analytes (e.g., using a nucleic acid probe or probe set that directly or indirectly hybridizes to a nucleic acid analyte) and/or non-nucleic acid analytes (e.g., using a labelling agent that includes a reporter oligonucleotide and binds directly or indirectly to a non-nucleic acid analyte) in any suitable combination.

Examples of non-nucleic acid analytes include, but are not limited to, lipids, carbohydrates, peptides, proteins, glycoproteins (N-linked or O-linked), lipoproteins, phosphoproteins, specific phosphorylated or acetylated variants of proteins, amidation variants of proteins, hydroxylation variants of proteins, methylation variants of proteins, ubiquitylation variants of proteins, sulfation variants of proteins, viral coat proteins, extracellular and intracellular proteins, antibodies, and antigen binding fragments.

Examples of nucleic acid analytes include DNA analytes such as single-stranded DNA (ssDNA), double-stranded DNA (dsDNA), genomic DNA, methylated DNA, specific methylated DNA sequences, fragmented DNA, mitochondrial DNA, in situ synthesized PCR products, and RNA/DNA hybrids. The DNA analyte can be a transcript of another nucleic acid molecule (e.g., DNA or RNA such as mRNA) present in a tissue sample.

Examples of nucleic acid analytes also include RNA analytes such as various types of coding and non-coding RNA. Examples of the different types of RNA analytes include messenger RNA (mRNA), including a nascent RNA, a pre-mRNA, a primary-transcript RNA, and a processed RNA, such as a capped mRNA (e.g., with a 5′ 7-methyl guanosine cap), a polyadenylated mRNA (poly-A tail at the 3′ end), and a spliced mRNA in which one or more introns have been removed. Also included in the analytes disclosed herein are non-capped mRNA, a non-polyadenylated mRNA, and a non-spliced mRNA. The RNA analyte can be a transcript of another nucleic acid molecule (e.g., DNA or RNA such as viral RNA) present in a tissue sample. Examples of a non-coding RNAs (ncRNA) that is not translated into a protein include transfer RNAs (tRNAs) and ribosomal RNAs (rRNAs), as well as small non-coding RNAs such as microRNA (miRNA), small interfering RNA (siRNA), Piwi-interacting RNA (piRNA), small nucleolar RNA (snoRNA), small nuclear RNA (snRNA), extracellular RNA (exRNA), small Cajal body-specific RNAs (scaRNAs), and the long ncRNAs such as Xist and HOTAIR.

In some embodiments described herein, an analyte may be a denatured nucleic acid, wherein the resulting denatured nucleic acid is single-stranded. The nucleic acid may be denatured, for example, optionally using formamide, heat, or both formamide and heat. In some embodiments, the nucleic acid is not denatured for use in a method disclosed herein.

In certain embodiments, an analyte can be extracted from a live cell. Processing conditions can be adjusted to ensure that a biological sample remains live during analysis, and analytes are extracted from (or released from) live cells of the sample. Live cell-derived analytes can be obtained only once from the sample or can be obtained at intervals from a sample that continues to remain in viable condition.

Methods and compositions disclosed herein can be used to analyze any number of analytes. For example, the number of analytes that are analyzed can be at least about 2, at least about 3, at least about 4, at least about 5, at least about 6, at least about 7, at least about 8, at least about 9, at least about 10, at least about 11, at least about 12, at least about 13, at least about 14, at least about 15, at least about 20, at least about 25, at least about 30, at least about 40, at least about 50, at least about 100, at least about 1,000, at least about 10,000, at least about 100,000 or more different analytes present in a region of the sample or within an individual feature of the substrate.

In any embodiment described herein, the analyte includes a target sequence. In some embodiments, the target sequence may be endogenous to the sample, generated in the sample, added to the sample, or associated with an analyte in the sample. In some embodiments, the target sequence is a single-stranded target sequence (e.g., a sequence in a rolling circle amplification product). In some embodiments, the analytes include one or more single-stranded target sequences. In one aspect, a first single-stranded target sequence is not identical to a second single-stranded target sequence. In another aspect, a first single-stranded target sequence is identical to one or more second single-stranded target sequence. In some embodiments, the one or more second single-stranded target sequence is included in the same analyte (e.g., nucleic acid) as the first single-stranded target sequence. Alternatively, the one or more second single-stranded target sequence is included in a different analyte (e.g., nucleic acid) from the first single-stranded target sequence.

### Labelling Agents

In some embodiments, provided herein are methods and compositions for analyzing endogenous analytes (e.g., RNA, ssDNA, and cell surface or intracellular proteins and/or metabolites) in a sample using one or more labelling agents. In some embodiments, an analyte labelling agent may include an agent that interacts with an analyte (e.g., an endogenous analyte in a sample). In some embodiments, the labelling agents can include a reporter oligonucleotide that is indicative of the analyte or portion thereof interacting with the labelling agent. For example, the reporter oligonucleotide may include a barcode sequence that permits identification of the labelling agent. In some cases, the sample contacted by the labelling agent can be further contacted with a probe (e.g., a single-stranded probe sequence), that hybridizes to a reporter oligonucleotide of the labelling agent, in order to identify the analyte associated with the labelling agent. In some embodiments, the analyte labelling agent includes an analyte binding moiety and a labelling agent barcode domain including one or more barcode sequences, e.g., a barcode sequence that corresponds to the analyte binding moiety and/or the analyte. An analyte binding moiety barcode includes a barcode that is associated with or otherwise identifies the analyte binding moiety. In some embodiments, by identifying an analyte binding moiety by identifying its associated analyte binding moiety barcode, the analyte to which the analyte binding moiety binds can also be identified. An analyte binding moiety barcode can be a nucleic acid sequence of a given length and/or sequence that is associated with the analyte binding moiety. An analyte binding moiety barcode can generally include any of the variety of aspects of barcodes described herein.

In some embodiments, the method includes one or more post-fixing (also referred to as post-fixation) steps after contacting the sample with one or more labelling agents.

In the methods and devices described herein, one or more labelling agents capable of binding to or otherwise coupling to one or more features may be used to characterize analytes, cells and/or cell features. In some instances, cell features include cell surface features. Analytes may include, but are not limited to, a protein, a receptor, an antigen, a surface protein, a transmembrane protein, a cluster of differentiation protein, a protein channel, a protein pump, a carrier protein, a phospholipid, a glycoprotein, a glycolipid, a cell-cell interaction protein complex, an antigen-presenting complex, a major histocompatibility complex, an engineered T-cell receptor, a T-cell receptor, a B-cell receptor, a chimeric antigen receptor, a gap junction, an adherens junction, or any combination thereof. In some instances, cell features may include intracellular analytes, such as proteins, protein modifications (e.g., phosphorylation status or other post-translational modifications), nuclear proteins, nuclear membrane proteins, or any combination thereof.

In some embodiments, an analyte binding moiety may include any molecule or moiety capable of binding to an analyte (e.g., a biological analyte, e.g., a macromolecular constituent). A labelling agent may include, but is not limited to, a protein, a peptide, an antibody (or an epitope binding fragment thereof), a lipophilic moiety (such as cholesterol), a cell surface receptor binding molecule, a receptor ligand, a small molecule, a bi-specific antibody, a bi-specific T-cell engager, a T-cell receptor engager, a B-cell receptor engager, a pro-body, an aptamer, a monobody, an affimer, a darpin, and a protein scaffold, or any combination thereof. The labelling agents can include (e.g., are attached to) a reporter oligonucleotide that is indicative of the cell surface feature to which the binding group binds. For example, the reporter oligonucleotide may include a barcode sequence that permits identification of the labelling agent. For example, a labelling agent that is specific to one type of cell feature (e.g., a first cell surface feature) may have coupled thereto a first reporter oligonucleotide, while a labelling agent that is specific to a different cell feature (e.g., a second cell surface feature) may have a different reporter oligonucleotide coupled thereto. For a description of exemplary labelling agents, reporter oligonucleotides, and methods of use, see, e.g., U.S. Pat. No. 10,550,429; U.S. Pat. Pub. 20190177800; and U.S. Pat. Pub. 20190367969, which are each incorporated by reference herein in their entirety.

In some embodiments, an analyte binding moiety includes one or more antibodies or antigen binding fragments thereof. The antibodies or antigen binding fragments including the analyte binding moiety can specifically bind to a target analyte. In some embodiments, the analyte is a protein (e.g., a protein on a surface of the biological sample (e.g., a cell) or an intracellular protein). In some embodiments, a plurality of analyte labelling agents including a plurality of analyte binding moieties bind a plurality of analytes present in a biological sample. In some embodiments, the plurality of analytes includes a single species of analyte (e.g., a single species of polypeptide). In some embodiments in which the plurality of analytes includes a single species of analyte, the analyte binding moieties of the plurality of analyte labelling agents are the same. In some embodiments in which the plurality of analytes includes a single species of analyte, the analyte binding moieties of the plurality of analyte labelling agents are the different (e.g., members of the plurality of analyte labelling agents can have two or more species of analyte binding moieties, wherein each of the two or more species of analyte binding moieties binds a single species of analyte, e.g., at different binding sites). In some embodiments, the plurality of analytes includes multiple different species of analyte (e.g., multiple different species of polypeptides).

In other instances, e.g., to facilitate sample multiplexing, a labelling agent that is specific to a particular cell feature may have a first plurality of the labelling agent (e.g., an antibody or lipophilic moiety) coupled to a first reporter oligonucleotide and a second plurality of the labelling agent coupled to a second reporter oligonucleotide.

In some aspects, these reporter oligonucleotides may include nucleic acid barcode sequences that permit identification of the labelling agent which the reporter oligonucleotide is coupled to. The selection of oligonucleotides as the reporter may provide advantages of being able to generate significant diversity in terms of sequence, while also being readily attachable to most biomolecules, e.g., antibodies, etc., as well as being readily detected, e.g., using sequencing or array technologies.

Attachment (coupling) of the reporter oligonucleotides to the labelling agents may be achieved through any of a variety of direct or indirect, covalent or non-covalent associations or attachments. For example, oligonucleotides may be covalently attached to a portion of a labelling agent (such a protein, e.g., an antibody or antibody fragment) using chemical conjugation techniques (e.g., Lightning-Link® antibody labelling kits available from Innova Biosciences), as well as other non-covalent attachment mechanisms, e.g., using biotinylated antibodies and oligonucleotides (or beads that include one or more biotinylated linker, coupled to oligonucleotides) with an avidin or streptavidin linker. Antibody and oligonucleotide biotinylation techniques are available. See, e.g., Fang, et al., “Fluoride-Cleavable Biotinylation Phosphoramidite for 5′-end-Labelling and Affinity Purification of Synthetic Oligonucleotides,” Nucleic Acids Res. Jan. 15, 2003; 31(2):708-715, which is entirely incorporated herein by reference for all purposes. Likewise, protein and peptide biotinylation techniques have been developed and are readily available. See, e.g., U.S. Pat. No. 6,265,552, which is entirely incorporated herein by reference for all purposes. Furthermore, click reaction chemistry may be used to couple reporter oligonucleotides to labelling agents. Commercially available kits, such as those from Thunderlink and Abcam, and techniques common in the art may be used to couple reporter oligonucleotides to labelling agents as appropriate. In another example, a labelling agent is indirectly (e.g., via hybridization) coupled to a reporter oligonucleotide including a barcode sequence that identifies the label agent. For instance, the labelling agent may be directly coupled (e.g., covalently bound) to a hybridization oligonucleotide that includes a sequence that hybridizes with a sequence of the reporter oligonucleotide. Hybridization of the hybridization oligonucleotide to the reporter oligonucleotide couples the labelling agent to the reporter oligonucleotide. In some embodiments, the reporter oligonucleotides are releasable from the labelling agent, such as upon application of a stimulus. For example, the reporter oligonucleotide may be attached to the labeling agent through a labile bond (e.g., chemically labile, photolabile, thermally labile, etc.) as generally described for releasing molecules from supports elsewhere herein. In some instances, the reporter oligonucleotides described herein may include one or more functional sequences that can be used in subsequent processing, such as an adapter sequence, a unique molecular identifier (UMI) sequence, a sequencer specific flow cell attachment sequence (such as an P5, P7, or partial P5 or P7 sequence), a primer or primer binding sequence, a sequencing primer or primer binding sequence (such as an R1, R2, or partial R1 or R2 sequence).

In some cases, the labelling agent can include a reporter oligonucleotide and a label. A label can be fluorophore, a radioisotope, a molecule capable of a colorimetric reaction, a magnetic particle, or any other suitable molecule or compound capable of detection. The label can be conjugated to a labelling agent (or reporter oligonucleotide) either directly or indirectly (e.g., the label can be conjugated to a molecule that can bind to the labelling agent or reporter oligonucleotide). In some cases, a label is conjugated to a first oligonucleotide that is complementary (e.g., hybridizes) to a sequence of the reporter oligonucleotide.

In some embodiments, multiple different species of analytes (e.g., polypeptides) from the biological sample can be subsequently associated with the one or more physical properties of the biological sample. For example, the multiple different species of analytes can be associated with locations of the analytes in the biological sample. Such information (e.g., proteomic information when the analyte binding moiety(ies) recognizes a polypeptide(s)) can be used in association with other spatial information (e.g., genetic information from the biological sample, such as DNA sequence information, transcriptome information (i.e., sequences of transcripts), or both). For example, a cell surface protein of a cell can be associated with one or more physical properties of the cell (e.g., a shape, size, activity, or a type of the cell). The one or more physical properties can be characterized by imaging the cell. The cell can be bound by an analyte labelling agent including an analyte binding moiety that binds to the cell surface protein and an analyte binding moiety barcode that identifies that analyte binding moiety. Results of protein analysis in a sample (e.g., a tissue sample or a cell) can be associated with DNA and/or RNA analysis in the sample.

### Products of Endogenous Analyte and/or Labelling Agent

In some embodiments, provided herein are methods and compositions for analyzing one or more products of an endogenous analyte and/or a labelling agent in a biological sample. In some embodiments, an endogenous analyte (e.g., a viral or cellular DNA or RNA) or a product (e.g., a hybridization product, a ligation product, an extension product (e.g., by a DNA or RNA polymerase), a replication product, a transcription/reverse transcription product, and/or an amplification product thereof is analyzed. In some aspects, the generation and/or processing of the analytes may be performed in the device and/or the analysis of the analytes may be performed in the device, such as by delivering reagents to a sample via a fluid source. For example, the generation, processing, and analysis may include but is not limited to reactions including hybridizations, ligations, binding, extension, amplifications, or other enzymatic reactions. In some embodiments, a labelling agent that directly or indirectly binds to an analyte in the biological sample is analyzed. In some embodiments, a product (e.g., a hybridization product, a ligation product, an extension product (e.g., by a DNA or RNA polymerase), a replication product, a transcription/reverse transcription product, and/or an amplification product of a labelling agent that directly or indirectly binds to an analyte in the biological sample is analyzed. In some embodiments, the reactions for generating any of the products (e.g., ligation, amplification, extension, hybridization) provided herein are performed in the devices provided herein.

### Hybridization

In some embodiments, a product of an endogenous analyte and/or a labelling agent is a hybridization product including the pairing of substantially complementary or complementary nucleic acid sequences within two different molecules, one of which is the endogenous analyte or the labelling agent (e.g., reporter oligonucleotide attached thereto). The other molecule can be another endogenous molecule or another labelling agent such as a probe. Pairing can be achieved by any process in which a nucleic acid sequence joins with a substantially or fully complementary sequence through base pairing to form a hybridization complex. For purposes of hybridization, two nucleic acid sequences are “substantially complementary” if at least 60% (e.g., at least 70%, at least 80%, or at least 90%) of their individual bases are complementary to one another.

### [0290]

Various probes and probe sets can be hybridized to an endogenous analyte and/or a labelling agent and each probe may include one or more barcode sequences. Exemplary barcoded probes or probe sets may be based on a padlock probe, a gapped padlock probe, a SNAIL (Splint Nucleotide Assisted Intramolecular Ligation) probe set, a PLAYR (Proximity Ligation Assay for RNA) probe set, a PLISH (Proximity Ligation in situ Hybridization) probe set, and RNA-templated ligation probes. The specific probe or probe set design can vary.

### Ligation

In some embodiments, a product of an endogenous analyte and/or a labelling agent is a ligation product. In some embodiments, the ligation product is formed between two or more endogenous analytes. In some embodiments, the ligation product is formed between an endogenous analyte and a labelling agent. In some embodiments, the ligation product is formed between two or more labelling agent. In some embodiments, the ligation product is an intramolecular ligation of an endogenous analyte. In some embodiments, the ligation product is an intramolecular ligation of a labelling agent, for example, the circularization of a circularizable probe or probe set upon hybridization to a target sequence. The target sequence can be included in an endogenous analyte (e.g., nucleic acid such as a genomic DNA or mRNA) or a product thereof (e.g., cDNA from a cellular mRNA transcript), or in a labelling agent (e.g., the reporter oligonucleotide) or a product thereof.

In some embodiments, the ligation involves chemical ligation. In some embodiments, the ligation involves template dependent ligation. In some embodiments, the ligation involves template independent ligation. In some embodiments, the ligation involves enzymatic ligation.

In some embodiments, the enzymatic ligation involves use of a ligase. In some aspects, the ligase used herein includes an enzyme that is commonly used to join polynucleotides together or to join the ends of a single polynucleotide. An RNA ligase, a DNA ligase, or another variety of ligase can be used to ligate two nucleotide sequences together. Ligases include ATP-dependent double-strand polynucleotide ligases, NAD-i-dependent double-strand DNA or RNA ligases and single-strand polynucleotide ligases, for example any of the ligases described in EC 6.5.1.1 (ATP-dependent ligases), EC 6.5.1.2 (NAD+-dependent ligases), EC 6.5.1.3 (RNA ligases). Specific examples of ligases include bacterial ligases such as E. coli DNA ligase, Tth DNA ligase, Thermococcus sp. (strain 9° N) DNA ligase (9° N™ DNA ligase, New England Biolabs), Taq DNA ligase, Ampligase™ (Epicentre Biotechnologies) and phage ligases such as T3 DNA ligase, T4 DNA ligase and T7 DNA ligase and mutants thereof. In some embodiments, the ligase is a T4 RNA ligase. In some embodiments, the ligase is a splintR ligase. In some embodiments, the ligase is a single stranded DNA ligase. In some embodiments, the ligase is a T4 DNA ligase. In some embodiments, the ligase is a ligase that has an DNA-splinted DNA ligase activity. In some embodiments, the ligase is a ligase that has an RNA-splinted DNA ligase activity.

In some embodiments, the ligation herein is a direct ligation. In some embodiments, the ligation herein is an indirect ligation. “Direct ligation” means that the ends of the polynucleotides hybridize immediately adjacently to one another to form a substrate for a ligase enzyme resulting in their ligation to each other (intramolecular ligation). Alternatively, “indirect” means that the ends of the polynucleotides hybridize non-adjacently to one another, i.e., separated by one or more intervening nucleotides or “gaps”. In some embodiments, said ends are not ligated directly to each other, but instead occurs either via the intermediacy of one or more intervening (so-called “gap” or “gap-filling” (oligo)nucleotides) or by the extension of the 3′ end of a probe to “fill” the “gap” corresponding to said intervening nucleotides (intermolecular ligation). In some cases, the gap of one or more nucleotides between the hybridized ends of the polynucleotides may be “filled” by one or more “gap” (oligo)nucleotide(s) which are complementary to a splint, padlock probe, or target nucleic acid. The gap may be a gap of 1 to 60 nucleotides or a gap of 1 to 40 nucleotides or a gap of 3 to 40 nucleotides. In specific embodiments, the gap may be a gap of about 1, 2, 3, 4, 5, 6, 7, 8, 9, or 10 or more nucleotides, of any integer (or range of integers) of nucleotides in between the indicated values. In some embodiments, the gap between said terminal regions may be filled by a gap oligonucleotide or by extending the 3′ end of a polynucleotide. In some cases, ligation involves ligating the ends of the probe to at least one gap (oligo)nucleotide, such that the gap (oligo)nucleotide becomes incorporated into the resulting polynucleotide. In some embodiments, the ligation herein is preceded by gap filling. In other embodiments, the ligation herein does not require gap filling.

In some embodiments, ligation of the polynucleotides produces polynucleotides with melting temperature higher than that of unligated polynucleotides. Thus, in some aspects, ligation stabilizes the hybridization complex containing the ligated polynucleotides prior to subsequent steps, including amplification and detection.

In some aspects, a high fidelity ligase, such as a thermostable DNA ligase (e.g., a Taq DNA ligase), is used. Thermostable DNA ligases are active at elevated temperatures, allowing further discrimination by incubating the ligation at a temperature near the melting temperature (Tm) of the DNA strands. This selectively reduces the concentration of annealed mismatched substrates (expected to have a slightly lower Tm around the mismatch) over annealed fully base-paired substrates. Thus, high-fidelity ligation can be achieved through a combination of the intrinsic selectivity of the ligase active site and balanced conditions to reduce the incidence of annealed mismatched dsDNA.

In some embodiments, the ligation herein is a proximity ligation of ligating two (or more) nucleic acid sequences that are in proximity with each other, e.g., through enzymatic means (e.g., a ligase). In some embodiments, proximity ligation can include a “gap-filling” step that involves incorporation of one or more nucleic acids by a polymerase, based on the nucleic acid sequence of a template nucleic acid molecule, spanning a distance between the two nucleic acid molecules of interest (see, e.g., U.S. Pat. No. 7,264,929, the entire contents of which are incorporated herein by reference). A wide variety of different methods can be used for proximity ligating nucleic acid molecules, including (but not limited to) “sticky-end” and “blunt-end” ligations. Additionally, single-stranded ligation can be used to perform proximity ligation on a single-stranded nucleic acid molecule. Sticky-end proximity ligations involve the hybridization of complementary single-stranded sequences between the two nucleic acid molecules to be joined, prior to the ligation event itself. Blunt-end proximity ligations generally do not include hybridization of complementary regions from each nucleic acid molecule because both nucleic acid molecules lack a single-stranded overhang at the site of ligation.

### Primer Extension and Amplification

In some embodiments, a product is a primer extension product of an analyte, a labelling agent, a probe or probe set bound to the analyte (e.g., a circularizable probe bound to genomic DNA, mRNA, or cDNA), or a probe or probe set bound to the labelling agent (e.g., a circularizable probe bound to one or more reporter oligonucleotides from the same or different labelling agents).

A primer is generally a single-stranded nucleic acid sequence having a 3′ end that can be used as a substrate for a nucleic acid polymerase in a nucleic acid extension reaction. RNA primers are formed of RNA nucleotides, and are used in RNA synthesis, while DNA primers are formed of DNA nucleotides and used in DNA synthesis. Primers can also include both RNA nucleotides and DNA nucleotides (e.g., in a random or designed pattern). Primers can also include other natural or synthetic nucleotides described herein that can have additional functionality. In some examples, DNA primers can be used to prime RNA synthesis and vice versa (e.g., RNA primers can be used to prime DNA synthesis). Primers can vary in length. For example, primers can be about 6 bases to about 120 bases. For example, primers can include up to about 25 bases. A primer, may in some cases, refer to a primer binding sequence. A primer extension reaction generally refers to any method where two nucleic acid sequences become linked (e.g., hybridized) by an overlap of their respective terminal complementary nucleic acid sequences (i.e., for example, 3′ termini). Such linking can be followed by nucleic acid extension (e.g., an enzymatic extension) of one, or both termini using the other nucleic acid sequence as a template for extension. Enzymatic extension can be performed by an enzyme including, but not limited to, a polymerase and/or a reverse transcriptase.

In some embodiments, a product of an endogenous analyte and/or a labelling agent is an amplification product of one or more polynucleotides, for instance, a circular probe or circularizable probe or probe set. In some embodiments, the amplifying is achieved by performing rolling circle amplification (RCA). In other embodiments, a primer that hybridizes to the circular probe or circularized probe is added and used as such for amplification. In some embodiments, the RCA includes a linear RCA, a branched RCA, a dendritic RCA, or any combination thereof.

In some embodiments, the amplification is performed at a temperature between or between about 20° C. and about 60° C. In some embodiments, the amplification is performed at a temperature between or between about 30° C. and about 40° C. In some aspects, the amplification step, such as the rolling circle amplification (RCA) is performed at a temperature between at or about 25° C. and at or about 50° C., such as at or about 25° C., 27° C., 29° C., 31° C., 33° C., 35° C., 37° C., 39° C., 41° C., 43° C., 45° C., 47° C., or 49° C.

In some embodiments, upon addition of a DNA polymerase in the presence of appropriate dNTP precursors and other cofactors, a primer is elongated to produce multiple copies of the circular template. This amplification step can utilize isothermal amplification or non-isothermal amplification.

### Target Sequences

A target sequence for a probe disclosed herein may be included in any analyte disclose herein, including an endogenous analyte (e.g., a viral or cellular nucleic acid), a labelling agent, or a product of an endogenous analyte and/or a labelling agent.

In some aspects, one or more of the target sequences includes one or more barcode(s), e.g., at least two, three, four, five, six, seven, eight, nine, ten, or more barcodes. Barcodes can spatially-resolve molecular components found in biological samples, for example, within a cell or a tissue sample. A barcode can be attached to an analyte or to another moiety or structure in a reversible or irreversible manner. A barcode can be added to, for example, a fragment of a deoxyribonucleic acid (DNA) or ribonucleic acid (RNA) sample before or during sequencing of the sample. Barcodes can allow for identification and/or quantification of individual sequencing-reads (e.g., a barcode can be or can include a unique molecular identifier or “UMI”). In some aspects, a barcode includes about 4, 5, 6, 7, 8, 9, 10, 11, 12, 13, 14, 15, 16, 17, 18, 19, 20, 21, 22, 23, 24, 25, 26, 27, 28, 29, 30, or more than 30 nucleotides.

In some embodiments, a barcode includes two or more sub-barcodes that together function as a single barcode. For example, a polynucleotide barcode can include two or more polynucleotide sequences (e.g., sub-barcodes) that are separated by one or more non-barcode sequences. In some embodiments, the one or more barcode(s) can also provide a platform for targeting functionalities, such as oligonucleotides, oligonucleotide-antibody conjugates, oligonucleotide-streptavidin conjugates, modified oligonucleotides, affinity purification, detectable moieties, enzymes, enzymes for detection assays or other functionalities, and/or for detection and identification of the polynucleotide.

In some embodiments, in a barcode sequencing method, barcode sequences are detected for identification of other molecules including nucleic acid molecules (DNA or RNA) longer than the barcode sequences themselves, as opposed to direct sequencing of the longer nucleic acid molecules. In some embodiments, a N-mer barcode sequence includes 4N complexity given a sequencing read of N bases, and a much shorter sequencing read may be required for molecular identification compared to non-barcode sequencing methods such as direct sequencing. For example, 1024 molecular species may be identified using a 5-nucleotide barcode sequence (45=1024), whereas 8 nucleotide barcodes can be used to identify up to 65,536 molecular species, a number greater than the total number of distinct genes in the human genome. In some embodiments, the barcode sequences contained in the probes or RCPs are detected, rather than endogenous sequences, which can be an efficient read-out in terms of information per cycle of sequencing. Because the barcode sequences are pre-determined, they can also be designed to feature error detection and correction mechanisms, see, e.g., U.S. Pat. Pub. 20190055594 and WO2019199579A1, which are hereby incorporated by reference in their entirety.

### Assays

The methods described herein may be useful for analysis methods in which specific reagents are added to a sample. In some embodiments, reagents are added to the sample in the device which include but are not limited to oligonucleotides (e.g., probes, dNTPs, primers), enzymes (e.g., endonucleases to fragment DNA, DNA polymerase enzymes, RNA polymerase, transposase, ligase, proteinase K, reverse transcriptase enzymes, including enzymes with terminal transferase activity, and DNAse), buffers and washes. In some embodiments, optical labels or dyes are added to the sample. In some embodiments, a sample can be collected from the device after performing steps of the assay described herein. In some embodiments, the device is used to perform or prepare sample for in situ analysis methods which include, e.g., in situ hybridization and in situ sequencing. In situ hybridization is a hybridization process in which labeled nucleic acids that are complementary to a specific nucleic acid (e.g., DNA or RNA) sequence in a biological sample hybridize to a portion or section of the sample (e.g., tissue) in which the nucleic acid is present. The methods described herein may be useful for array-based methods in which specific reagents are contacted with a sample. In some embodiments, the surface of the fluidic interface layer or substrate layer may have an array of bound reagents. In some embodiments, a device is used to deliver reagents to the sample which is deposited on the array.

The labeled nucleic acids, also referred to as probes, are generally short oligonucleotides in which at least a portion of the oligonucleotide is a reverse complement to a target nucleic acid of interest. The probes may include additional components in addition to the hybridization portion. For example, the probes may include additional sequences (e.g., barcode sequences), that are unique labels or identifiers to convey information about the nucleic acid being detected. The probes may further include a label attached thereto, directly or indirectly. The label may be, e.g., an optical label, a molecular label (e.g., an antigen), a radiolabel, or a field attractable label (e.g., electric or magnetic). In some embodiments the optical label is a fluorescent label, e.g., as used in fluorescence in situ hybridization (FISH). A fluorescent label can be detected by routine optical detection methods known in the art.

Optical detection may be performed by any detector capable of measuring light (e.g., the emitted, scattered, or attenuated light) from the label. Suitable detectors include, but are not limited to, a spectrometer, a light meter, a photometer, a photodiode, a photomultiplier tube, a CCD array, a CMOS sensor, or a photovoltaic device.

In situ methods may first include fixing and/or permeabilizing a biological sample (e.g., tissue). The biological sample may be provided in the device, e.g., on a substrate layer. The sample may be permeabilized by adding a fluid, such as a solvent (e.g., acetone and methanol) or a detergent (e.g., TRITON X-100, NP-40, TWEEN 20, saponin, digitonin, and Leucoperm), to the sample. Permeabilization may allow or enhance access of the probes for the intracellular space of the sample.

In some embodiments, a plurality of probes is used, e.g., for ease of detection and/or signal amplification, such as any probes described herein. For example, a first probe may include a nucleic acid sequence that hybridizes to a target nucleic acid in the sample. A secondary probe that includes a label (e.g., optical label, e.g., fluorescent label) may then be added that hybridizes to the first probe. In some embodiments, a plurality of secondary or higher order (e.g., tertiary, quaternary) detection probes are added. Each probe may be provided by a separate fluid source. Each probe may be provided by a single fluid source that includes a plurality of distinct probes.

When a probe that includes a detection label is added, the unbound probes with detection labels can be washed away and the signal can be detected, e.g., via fluorescence microscopy.

In some embodiments, the signal or template target nucleic acid is amplified. In some embodiments, an analyte (e.g., target nucleic acid) can be amplified using an enzyme, e.g., by polymerase chain reaction (PCR) or rolling circle amplification (RCA). The target nucleic acid may be replicated, e.g., by using the probe as a primer to initiate DNA or RNA synthesis. In such an embodiment, one or more fluids are added (e.g., sequentially) to the sample to provide the reagents for nucleic acid synthesis. Suitable reagents include, but are not limited to, probes, primers, nucleotide triphosphates (NTPs, e.g., dNTPs), sequencing terminators, dyes, polymerases, ligases, transcriptases (e.g., reverse transcriptases), labels, and the like.

In some embodiments, the methods described herein includes in situ sequencing or sequence detection. One such process includes temporal multiplexing of barcoded probes. In some embodiments, a primary probe or set of primary probes (e.g., 24 primary probes) hybridize to a target nucleic acid (e.g., mRNA) in the sample. Each probe may contain a barcode attached thereto. The barcodes may then be detected by contacting with one or more probes each labeled with a fluorescent label which emits a signal. Each round of barcoding may be initiated by flowing the desired probe from a new fluid source. The labels may be detected using different excitation wavelengths (e.g., 640 nm, 561 nm, or 488 nm) during different barcoding rounds. By compiling the spatiotemporal patterns of each fluorescent signal at a location, the unique set of ordered barcode sequences that corresponds to a particular gene can be determined. Such a method may allow multiplex sequencing of a large number of (e.g., of 100, 1,000, 10,000, or more) nucleic acids, e.g., up to 90,000 transcripts per cell. This method also allows for efficient quantification of low-copy number nucleic acids.

In some embodiments, the in situ detection and/or in situ sequencing is performed in three dimensions. In this embodiment, the biological sample may be sequence by using a probe that includes a unique gene identifier. The probe may be ligated, thereby allowing extension and amplification of the target sequence. In some embodiments, the amplification product can then be modified with a chemical moiety that polymerizes in the presence of a polymerization initiator. In some embodiments, an amplified product may be embedded within a polymerized matrix (e.g., a hydrogel), thereby creating spatially fixed three-dimensional target analytes of the biological sample.

In some embodiments, the in situ sequencing includes sequencing by ligation. In this embodiment, fluorescently labeled probes with two known bases followed by degenerate or universal bases hybridize to a temple. A ligase immobilizes the complex and the biological sample is imaged to detect the label on the probe. Following detection, the fluorophore is cleaved from the probe along with several bases, revealing a free 5′ phosphate. This process of hybridization, ligation, imaging, and cleavage can be repeating in multiple rounds, thereby allowing identification of, e.g., 2 out of every 5 bases. After a round of probe extension, all probes and anchors are removed and the cycle can begin again with an offset anchor, thus allowing sequencing of a new register of the target.

In another embodiment, sequencing by ligation includes labeled probes with a known base (e.g., A, C, T, or G) flanked on each side of the known base by degenerate or universal bases that hybridize to a template (e.g., three or four bases on each side). Each probe contains a different fluorescent label corresponding to each individual base. Each round of sequencing includes hybridizing a probe with a known base, ligation of the probe, detection, and optionally, cleavage of the fluorescent label. Sequencing can be performed in a plus or minus direction, and rounds of sequencing can begin again with an offset anchor, thus allowing sequencing of a new register of the target.

In some embodiments, detection of one or more analytes (e.g., protein analytes) can be performed using one or more analyte capture agents. In some embodiment, the devices described herein may include one or more analyte capture agents, e.g., an array of oligonucleotides. In some aspects, the array may include a bead array. As used herein, an “analyte capture agent” refers to an agent that interacts with an analyte (e.g., an analyte in a biological sample) and with a capture probe (e.g., a capture probe attached to a substrate or a feature) to identify the analyte. In some embodiments, the analyte capture agent includes: (i) an analyte binding moiety (e.g., that binds to an analyte), for example, an antibody or antigen-binding fragment thereof; (ii) analyte binding moiety barcode; and (iii) an analyte capture sequence. As used herein, the term “analyte binding moiety barcode” refers to a barcode that is associated with or otherwise identifies the analyte binding moiety. As used herein, the term “analyte capture sequence” refers to a region or moiety configured to hybridize to, bind to, couple to, or otherwise interact with a capture domain of a capture probe. In some cases, an analyte binding moiety barcode (or portion thereof) may be able to be removed (e.g., cleaved) from the analyte capture agent. Additional description of analyte capture agents can be found in Section (II)(b)(ix) of WO 2020/176788 and/or Section (II)(b)(viii) U.S. Patent Application Publication No. 2020/0277663.

There are at least two methods to associate a spatial barcode with one or more neighboring cells, such that the spatial barcode identifies the one or more cells, and/or contents of the one or more cells, as associated with a particular spatial location. One method is to promote analytes or analyte proxies (e.g., intermediate agents) out of a cell and towards a spatially-barcoded array (e.g., including spatially-barcoded capture probes). Another method is to cleave spatially-barcoded capture probes from an array and promote the spatially-barcoded capture probes towards and/or into or onto the biological sample.

In some cases, capture probes may be configured to prime, replicate, and consequently yield optionally barcoded extension products from a template (e.g., a DNA or RNA template, such as an analyte or an intermediate agent (e.g., a ligation product or an analyte capture agent), or a portion thereof), or derivatives thereof (see, e.g., Section (II)(b)(vii) of WO 2020/176788 and/or U.S. Patent Application Publication No. 2020/0277663 regarding extended capture probes). In some cases, capture probes may be configured to form ligation products with a template (e.g., a DNA or RNA template, such as an analyte or an intermediate agent, or portion thereof), thereby creating ligations products that serve as proxies for a template.

As used herein, an “extended capture probe” refers to a capture probe having additional nucleotides added to the terminus (e.g., 3′ or 5′ end) of the capture probe thereby extending the overall length of the capture probe. For example, an “extended 3′ end” indicates additional nucleotides were added to the most 3′ nucleotide of the capture probe to extend the length of the capture probe, for example, by polymerization reactions used to extend nucleic acid molecules including templated polymerization catalyzed by a polymerase (e.g., a DNA polymerase or a reverse transcriptase). In some embodiments, extending the capture probe includes adding to a 3′ end of a capture probe a nucleic acid sequence that is complementary to a nucleic acid sequence of an analyte or intermediate agent specifically bound to the capture domain of the capture probe. In some embodiments, the capture probe is extended using reverse transcription. In some embodiments, the capture probe is extended using one or more DNA polymerases. The extended capture probes include the sequence of the capture probe and the sequence of the spatial barcode of the capture probe.

In some embodiments, extended capture probes are amplified (e.g., in bulk solution or on the array) to yield quantities that are sufficient for downstream analysis, e.g., via DNA sequencing. In some embodiments, extended capture probes (e.g., DNA molecules) act as templates for an amplification reaction (e.g., a polymerase chain reaction).

Additional variants of spatial analysis methods, including in some embodiments, an imaging step, are described in Section (II)(a) of WO 2020/176788 and/or U.S. Patent Application Publication No. 2020/0277663. Analysis of captured analytes (and/or intermediate agents or portions thereof), for example, including sample removal, extension of capture probes, sequencing (e.g., of a cleaved extended capture probe and/or a cDNA molecule complementary to an extended capture probe), sequencing on the array (e.g., using, for example, in situ hybridization or in situ ligation approaches), temporal analysis, and/or proximity capture, is described in Section (II)(g) of WO 2020/176788 and/or U.S. Patent Application Publication No. 2020/0277663. Some quality control measures are described in Section (II)(h) of WO 2020/176788 and/or U.S. Patent Application Publication No. 2020/0277663.

Spatial information can provide information of biological and/or medical importance. For example, the methods and compositions described herein can allow for: identification of one or more biomarkers (e.g., diagnostic, prognostic, and/or for determination of efficacy of a treatment) of a disease or disorder; identification of a candidate drug target for treatment of a disease or disorder; identification (e.g., diagnosis) of a subject as having a disease or disorder; identification of stage and/or prognosis of a disease or disorder in a subject; identification of a subject as having an increased likelihood of developing a disease or disorder; monitoring of progression of a disease or disorder in a subject; determination of efficacy of a treatment of a disease or disorder in a subject; identification of a patient subpopulation for which a treatment is effective for a disease or disorder; modification of a treatment of a subject with a disease or disorder; selection of a subject for participation in a clinical trial; and/or selection of a treatment for a subject with a disease or disorder.

Spatial information can provide information of biological importance. For example, the methods and compositions described herein can allow for: identification of transcriptome and/or proteome expression profiles (e.g., in healthy and/or diseased tissue); identification of multiple analyte types in close proximity (e.g., nearest neighbor analysis); determination of up- and/or down-regulated genes and/or proteins in diseased tissue; characterization of tumor microenvironments; characterization of tumor immune responses; characterization of cells types and their co-localization in tissue; and identification of genetic variants within tissues (e.g., based on gene and/or protein expression profiles associated with specific disease or disorder biomarkers).

Typically, for spatial array-based methods, a substrate layer (e.g., as described herein) functions as a support for direct or indirect attachment of capture probes to features of the array. A “feature” is an entity that acts as a support or repository for various molecular entities used in spatial analysis. In some embodiments, some or all of the features in an array are functionalized for analyte capture. Exemplary substrates are described in Section (II)(c) of WO 2020/176788 and/or U.S. Patent Application Publication No. 2020/0277663. Exemplary features and geometric attributes of an array can be found in Sections (II)(d)(i), (II)(d)(iii), and (II)(d)(iv) of WO 2020/176788 and/or U.S. Patent Application Publication No. 2020/0277663.

Generally, analytes and/or intermediate agents (or portions thereof) can be captured when contacting a biological sample with a substrate including capture probes (e.g., a substrate with capture probes embedded, spotted, printed, fabricated on the substrate, or a substrate with features (e.g., beads, wells) including capture probes). As used herein, “contact,” “contacted,” and/or “contacting,” a biological sample with a substrate refers to any contact (e.g., direct or indirect) such that capture probes can interact (e.g., bind covalently or non-covalently (e.g., hybridize)) with analytes from the biological sample. Capture can be achieved actively (e.g., using electrophoresis) or passively (e.g., using diffusion). Analyte capture is further described in Section (II)(e) of WO 2020/176788 and/or U.S. Patent Application Publication No. 2020/0277663.

In some cases, spatial analysis can be performed by attaching and/or introducing a molecule (e.g., a peptide, a lipid, or a nucleic acid molecule) having a barcode (e.g., a spatial barcode) to a biological sample (e.g., to a cell in a biological sample). In some embodiments, a plurality of molecules (e.g., a plurality of nucleic acid molecules) having a plurality of barcodes (e.g., a plurality of spatial barcodes) are introduced to a biological sample (e.g., to a plurality of cells in a biological sample) for use in spatial analysis. In some embodiments, after attaching and/or introducing a molecule having a barcode to a biological sample, the biological sample can be physically separated (e.g., dissociated) into single cells or cell groups for analysis. Some such methods of spatial analysis are described in Section (III) of WO 2020/176788 and/or U.S. Patent Application Publication No. 2020/0277663.

In some embodiments, the macromolecular components (e.g., analytes) of individual biological samples (e.g., cells) can be identified or detected with unique identifiers (e.g., barcodes) such that upon characterization of those macromolecular components, such that any given component (e.g., bioanalyte) may be traced to the biological sample (e.g., cell) from which it was obtained. The ability to attribute characteristics to individual biological samples or groups of biological samples is provided by the assignment of unique identifiers specifically to an individual biological sample or groups of biological samples. Unique identifiers, for example, in the form of nucleic acid barcodes, can be assigned or associated with individual biological samples (e.g., cells) or populations of biological samples (e.g., cells), or genes (e.g., mRNA transcripts, in order to tag or label the biological sample's macromolecular components (and as a result, its characteristics) with the unique identifiers. These unique identifiers can then be used to attribute the biological sample's components and characteristics to an individual biological sample or group of biological samples.

In some aspects, the unique identifiers are provided in the form of oligonucleotides that include nucleic acid barcode sequences that may be attached to or otherwise associated with the nucleic acid contents of individual biological sample, or to other components of the biological sample, and particularly to fragments of those nucleic acids.

The nucleic acid barcode sequences can include from 6 to about 20 or more nucleotides within the sequence of the oligonucleotides. In some cases, the length of a barcode sequence may be 6, 7, 8, 9, 10, 11, 12, 13, 14, 15, 16, 17, 18, 19, 20 nucleotides or longer. In some cases, the length of a barcode sequence may be at least 6, 7, 8, 9, 10, 11, 12, 13, 14, 15, 16, 17, 18, 19, 20 nucleotides or longer. In some cases, the length of a barcode sequence may be at most 6, 7, 8, 9, 10, 11, 12, 13, 14, 15, 16, 17, 18, 19, 20 nucleotides or shorter. These nucleotides may be completely contiguous, i.e., in a single stretch of adjacent nucleotides, or they may be separated into two or more separate subsequences that are separated by 1 or more nucleotides. In some cases, separated barcode subsequences can be from about 4 to about 16 nucleotides in length. In some cases, the barcode subsequence may be 4, 5, 6, 7, 8, 9, 10, 11, 12, 13, 14, 15, 16 nucleotides or longer. In some cases, the barcode subsequence may be at least 4, 5, 6, 7, 8, 9, 10, 11, 12, 13, 14, 15, 16 nucleotides or longer. In some cases, the barcode subsequence may be at most 4, 5, 6, 7, 8, 9, 10, 11, 12, 13, 14, 15, 16 nucleotides or shorter.

Moieties (e.g., oligonucleotides) used in the methods described herein can also include other functional sequences useful in processing of nucleic acids from biological samples contained in the droplet. These sequences include, for example, targeted or random/universal amplification primer sequences for amplifying the genomic DNA from the individual biological samples within the droplets while attaching the associated barcode sequences, sequencing primers or primer recognition sites, hybridization or probing sequences, e.g., for identification of presence of the sequences or for pulling down barcoded nucleic acids, or any of a number of other potential functional sequences.

The methods described herein may include providing molecular labels, e.g., via a fluid source. The molecular labels may include barcodes (e.g., nucleic acid barcodes). The molecular labels can be provided to the biological sample based on a number of different methods including, without limitation, microinjection, electroporation, liposome-based methods, nanoparticle-based methods, and lipophilic moiety-barcode conjugate methods. For instance, a lipophilic moiety conjugated to a nucleic acid barcode may be contacted with cells or particulate components of interest. The lipophilic moiety may insert into the plasma membrane of a cell thereby labeling the cell with the barcode. The devices and methods of the present disclosure may result in molecular labels being present on (i) the interior of a cell or particulate component and/or (ii) the exterior of a cell or particulate component (e.g., on or within the cell membrane). These and other suitable methods will be appreciated by those skilled in the art (see U.S. Pub. Nos. US20190177800, US20190323088, US20190338353, and US20200002763, each of which is incorporated herein by reference in its entirety).

In an example, a fluid is provided that includes large numbers of the above-described barcoded oligonucleotides releasably attached to a label. In some cases, a fluid will provide a diverse barcode sequence library that includes at least about 1,000 different barcode sequences, at least about 5,000 different barcode sequences, at least about 10,000 different barcode sequences, at least about 50,000 different barcode sequences, at least about 100,000 different barcode sequences, at least about 1,000,000 different barcode sequences, at least about 5,000,000 different barcode sequences, or at least about 10,000,000 different barcode sequences, or more.

Oligonucleotides may be releasable from the labels (e.g., optical label, e.g., fluorescent label) upon the application of a particular stimulus. In some cases, the stimulus may be a photo-stimulus, e.g., through cleavage of a photo-labile linkage that releases the oligonucleotides. In other cases, a thermal stimulus may be used, where increase in temperature will result in cleavage of a linkage or other release of the oligonucleotides from the label. In still other cases, a chemical stimulus is used that cleaves a linkage of the oligonucleotides to the label, or otherwise results in release of the oligonucleotides from the label, e.g., beads.

### Methods of Device Manufacture

The devices of the present disclosure may be fabricated in any of a variety of conventional ways. These structures may be fabricated in whole or in part from polymeric materials, such as polyethylene or polyethylene derivatives, such as cyclic olefin copolymers (COC), polymethylmethacrylate (PMMA), polydimethylsiloxane (PDMS), polycarbonate, polystyrene, polypropylene, polyvinyl chloride, polytetrafluoroethylene, polyoxymethylene, polyether ether ketone, polycarbonate, polystyrene, or the like, or they may be fabricated in whole or in part from inorganic materials, such as silicon, or other silica based materials, e.g., glass, quartz, fused silica, borosilicate glass, metals, ceramics, and combinations thereof.

A gasket of the present disclosure may be made in whole or in part from, e.g., a polymer, e.g., a silicone (e.g., silicone rubbers, e.g., PDMS), fluorosilicone, FKM, FFKM, COC elastomer, etc. The gasket may include an elastomeric polymer, e.g., be cut or formed from an elastomeric material, or precursors thereof, e.g., to allow the gasket to be compressible. A gasket may be a composite of compressible and incompressible materials, e.g., an elastomeric polymer bonded to a non-elastomeric polymer, e.g., formed by bonding (e.g., thermally or with adhesive) two or more materials together. Gaskets may include thermoset or thermoplastic polymers, or a combination thereof. A gasket may be coated, e.g., to include a one-sided adhesive, a double-sided adhesive, a polymer coating, or a hydrophobic coating. A hydrophobic coating on the gasket may act to improve sealing (e.g., to prevent leaks), and/or to reduce adhesion between the gasket and the fluidic interface layer and/or substrate layer, e.g., to allow for easier removal.

A gasket of the disclosure may be formed in place on the fluidic interface layer. For example, a gasket may be printed in place, e.g., using screen printing, CNC controlled nozzle deposition, 3D printing of elastomers on the surface, UV curable processes (e.g., stereolithography), etc. In some embodiments, a gasket may be formed on the fluidic interface by dispensing beads of curable elastomers, e.g., moisture or UV curable elastomers, or, e.g., two-part RTV elastomers. In some embodiments, a gasket may be produced by laser cutting of a continuous gasket layer already laminated on to the substrate layer or fluidic interface layer.

The fluidic interface layer and substrate layers may be made in whole or in part from glass, polymer (e.g., polystyrene, polycarbonate, polyethylene terephthalate, polypropylene, polyethylene, PTFE, COC, PMMA, etc.), plastic, ceramic, metal, or a combination thereof. The fluidic interface may be constructed of multiple layers, e.g., a top layer and a bottom layer.

Polymeric device components may be fabricated using any of a number of processes including soft lithography, embossing techniques, micromachining, e.g., laser machining, or, in some aspects, injection molding of the layer components that include the defined channels as well as other structures, e.g., reservoirs, integrated functional components, etc. In such cases, a laminating layer may be adhered to the molded structured part through readily available methods, including thermal lamination, solvent based lamination, sonic welding, or the like.

As will be appreciated, structures included of inorganic materials also may be fabricated using known techniques. For example, structures such as channels or reservoirs may be micro-machined into surfaces or etched into the surfaces using standard photolithographic techniques. In some aspects, the devices or components thereof may be fabricated using three-dimensional printing techniques to fabricate the channel or other structures of the devices and/or their discrete components.

### Methods for Surface Modifications

The disclosure features methods for producing a flow device (e.g., a microfluidic device) that has a surface modification, e.g., a surface with a modified water contact angle. The methods may be employed to modify the surface of a device such that a liquid can “wet” the surface by altering the contact angle the liquid makes with the surface.

Devices to be modified with surface coating agents may be primed, e.g., pre-treated, before coating processes occur. In certain embodiments, the first contact angle is greater than the water contact angle of the primed surface. In other embodiments, the first contact angle is greater than the water contact angle of the device component surface. Thus, the method allows for the differential coating of surfaces within or on the device.

A surface may be primed by depositing a metal oxide onto it. Example metal oxides useful for priming surfaces include, but are not limited to, Al2O3, TiO2, SiO2, or a combination thereof. Other metal oxides useful for surface modifications are known in the art. The metal oxide can be applied to the surface by standard deposition techniques, including, but not limited to, atomic layer deposition (ALD), physical vapor deposition (PVD), e.g., sputtering, chemical vapor deposition (CVD), or laser deposition. Other deposition techniques for coating surfaces, e.g., liquid-based deposition, are known in the art. For example, an atomic layer of Al2O3 can be prepared on a surface by depositing trimethylaluminum (TMA) and water.

In some cases, the coating agent may create a surface that has a water contact angle greater than 90°, e.g., hydrophobic or fluorophillic, or may create a surface with a water contact angle of less than 90°, e.g., hydrophilic. For example, a fluorophillic surface may be created by flowing fluorosilane (e.g., H3FSi) through a primed device surface, e.g., a surface coated in a metal oxide. The priming of the surfaces of the device enhances the adhesion of the coating agents to the surface by providing appropriate surface functional groups. In some cases, the coating agent used to coat the primed surface may be a liquid reagent.

While the disclosed subject matter is described herein in terms of certain preferred embodiments, those skilled in the art will recognize that various modifications and improvements may be made to the disclosed subject matter without departing from the scope thereof. Moreover, although individual features of one embodiment of the disclosed subject matter may be discussed herein or shown in the drawings of the one embodiment and not in other embodiments, it should be apparent that individual features of one embodiment may be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A method comprising:
providing a plurality of reservoirs, each reservoir of the plurality of reservoirs containing a reagent;
using an aspiration device to aspirate a first reagent from a first reservoir of the plurality of reservoirs;
flowing the first reagent from the aspiration device through a first fluid channel;
delivering at least a portion of the first reagent from an end of the first fluid channel into an inlet of a closed flow cell;
using the aspiration device to aspirate at least one bubble into the first fluid channel, the bubble upstream of the first liquid reagent;
using the aspiration device to aspirate a second reagent from a second reservoir of the plurality of reservoirs;
flowing the second reagent from the aspiration device through the first fluid channel, the second liquid reagent upstream of the at least one bubble, wherein the at least one bubble separates the first liquid reagent and the second liquid reagent in the first fluid channel;
diverting the at least one bubble from the first fluid channel;
delivering the second reagent from the end of the first fluid channel into the inlet of the closed flow cell.

2. (canceled)

3. The method of claim 1, wherein the aspiration device is fluidically coupled to the first fluid channel.

4. The method of claim 1, wherein the closed flow cell comprises an outlet fluidically coupled to a second flow channel, wherein a waste container is disposed at an end of the second flow channel;
the method further comprising:
flowing the first reagent out the outlet, through the second flow channel, and into the waste container; and
flowing the second reagent out the outlet, through the second flow channel, and into the waste container.

5. (canceled)

6. (canceled)

7. The method of claim 4, wherein the second flow channel comprises a pump.

8. (canceled)

9. (canceled)

10. (canceled)

11. The method of claim 1, wherein the first flow channel comprises a de-bubbler, wherein diverting the at least one bubble includes flowing the at least one bubble through the de-bubbler, the de-bubbler configured to remove the at least one bubble from the first fluid channel.

12. The method of claim 11, wherein the de-bubbler comprises a gas-permeable membrane.

13. The method of claim 1, wherein the at least one bubble is diverted from the first fluid channel prior to delivering the second reagent to the inlet of the closed flow cell.

14. The method of claim 1, wherein the first flow channel comprises a valve, a bubble detector, and a bypass channel in fluid communication with the valve, wherein diverting the at least one bubble includes operating the valve to direct the at least one bubble to the bypass channel when the bubble is located at a bubble detector.

15. The method of claim 14, further comprising determining a flow rate in the first fluid channel by measuring a period of time for the at least one bubble to pass through a series of bubble detectors, wherein the valve directs the at least one bubble to the bypass channel for a period of time determined by the flow rate, wherein the flow rate is determined based on detection of a meniscus of the first or second reagent at each bubble detector.

16. (canceled)

17. (canceled)

18. The method of claim 1, wherein a biological sample is positioned within the closed flow cell, wherein delivering the first reagent comprises contacting the biological sample with the first reagent thereby performing a first reaction on the biological sample, wherein delivering the second reagent comprises contacting the biological sample with the second reagent thereby performing a second reaction on the biological sample.

19. (canceled)

20. (canceled)

21. (canceled)

22. (canceled)

23. (canceled)

24. A system comprising:
a plurality of reservoirs comprising a plurality of reagents, each reservoir of the plurality of reservoirs containing a reagent of the plurality of reagents;
a pump configured to cause a flow of the plurality of reagents;
an aspiration device coupled to a first end of a first fluid channel, the aspiration head configured to move about an X-axis, Y-axis and Z-axis, and to aspirate the plurality of reagents from the reagent reservoir into the first fluid channel,
wherein the aspiration device is displaced outside the reagent reservoir between aspirating each reagent to draw at least one bubble into the first fluid channel such that the at least one bubble is disposed between adjacent reagents within the first fluid channel;
a closed flow cell having an inlet and an outlet, wherein the inlet is coupled to a second end of the first fluid channel; and
a de-bubbler coupled to the first fluid channel and disposed upstream of the closed flow cell, the de-bubbler configured to divert the at least one bubble from the first fluid channel.

25. The system of claim 24, further comprising:
a second fluid channel, wherein a first end of the second fluid channel is coupled to the outlet of the closed flow cell; and
a waste container disposed at a second end of the second fluid channel.

26. (canceled)

27. The system of claim 24, wherein the pump is coupled to the second fluid channel.

28. The system of claim 24, wherein the aspiration device comprises an air displacement pipette.

29. The system of claim 24, wherein the de-bubbler comprises a gas-permeable membrane.

30. The system of claim 24, wherein the de-bubbler comprises one or more bubble sensors.

31. The system of claim 30, wherein the de-bubbler includes a flow meter for determining a time interval for diverting the at least one bubble.

32. The system of claim 30, further comprising a valve coupled to the first fluid channel and a bypass channel in fluid communication with the valve, the bypass channel receiving the at least one bubble from the first fluid channel.

33. The system of claim 32, wherein a first bubble sensor and a second bubble sensor are coupled in series to the first fluid channel, wherein the valve is configured to close the first fluid channel upon detection of a bubble at each bubble sensor and reopen the first fluid channel when no bubble is detected at the second bubble sensor.

34. (canceled)

35. The system of claim 24, wherein, after a first reagent is delivered to the flow cell, the at least one bubble is diverted from the first fluid channel, and a second reagent is delivered to the closed flow cell.
